(19) United States
(12) Patent Application Publication
(10) Pub. No.: US 2026/0030476 A1
(43) Pub. Date: Jan. 29, 2026

(54) SYSTEM AND METHOD FOR EVALUATING ARTIFICIAL INTELLIGENCE AGENTS DEPLOYED IN AN ENTERPRISE COMPUTING ENVIRONMENT

(71) Applicant: KPMG LLP, New York, NY (US)

(72) Inventor: Swaminathan CHANDRASEKARAN, Coppell, TX (US)

(21) Appl. No.: 19/349,743

(22) Filed: Oct. 3, 2025

Related U.S. Application Data
(63) Continuation-in-part of application No. 19/270,726, filed on Jul. 16, 2025.
(60) Provisional application No. 63/672,148, filed on Jul. 16, 2024.

(51) Int. Cl. G06N 3/004

(52) U.S. Cl. CPC G06N 3/004

(57) ABSTRACT

A computer-implemented system and method for evaluating an AI agent associated with an enterprise computing environment by aggregating a plurality of AI agents associated with the enterprise computing environment, and evaluating, with an agent evaluation unit, a selected AI agent of the plurality of AI agents using evaluation data, wherein the evaluation data includes operational behavior data and trustworthiness data. The agent evaluation unit can be configured to determine a total agent evaluation score for the selected AI agent from a plurality of category specific evaluation scores. The agent specific categories can have associated therewith a category evaluation score and the agent specific categories can include categories associated with the operational behavior and the trustworthiness of the selected AI agent. An AI-based intervention can be applied in response to the total agent evaluation score.

### RELATED APPLICATIONS

The present application claims priority to and is a continuation-in-part patent application of U.S. patent application Ser. No. 19/270,726, filed on Jul. 16, 2025, and entitled System and Method For Dynamic Multi-Party Verification of Generative Artificial Intelligence Systems, which in turn claims priority to U.S. provisional patent application Ser. No. 63/672,148, filed on Jul. 16, 2024, and entitled System and Method for Dynamic Multi-Party Verification of Generative Language Models, the contents of which are herein incorporated by reference.

### BACKGROUND OF THE INVENTION

The present invention generally relates to the use of artificial intelligence (AI) agents and associated systems, and more particularly relates to systems and methods for evaluating AI agents in an enterprise computing environment.

In recent years, there has been a surge in the development and deployment of AI agents across various industries and domains. Enterprises are increasingly adopting AI agents to automate processes, assist decision-making, and enhance user experiences. The AI agents are not simple chatbots, but rather they are goal-driven software entities that plan and take actions autonomously or semi-autonomously. The AI agents leverage reasoning engines, such as large language models (LLMs), utilize multiple tools, and make decisions based on context and memory.

As enterprises scale their use of AI agents across diverse workflows, ranging from customer support to financial operations, the complexity of the AI agents and their interactions grow significantly. However, current enterprise computing environments lack robust mechanisms to evaluate how the AI agents perform in real-world conditions. Traditional metrics like accuracy or response time are insufficient because they fail to capture critical dimensions such as goal fulfillment, contextual reasoning (e.g., effectively employ relevant context, knowledge, and memory), adaptability (e.g., how the AI agent handle dynamic environments and evolving tasks), compliance and risk (e.g., did the AI agent adhere to enterprise policies and regulatory requirements), tool use (e.g., did the AI agent select and execute the appropriate tools effectively to accomplish its goals), and consistency and reliability (did the AI agent demonstrate predictable behavior and maintain planner reliability across repeated or similar tasks?).

Additionally, conventional AI agents, such as chatbots and virtual assistants, are susceptible to biases and inaccuracies inherent in the training data, which can lead to biased decision-making and unethical outcomes in certain scenarios. Privacy and data security concerns further complicate their deployment, particularly when handling sensitive or regulated information. Moreover, orchestrating multiple AI agents remains a significant challenge. Existing systems struggle to coordinate AI agents with overlapping or complementary capabilities. When multiple decision paths exist, the conventional AI agents often lack the ability to determine the optimal course of action or to route information effectively. These limitations hinder scalability, increase operational risk, and reduce trust in AI-driven enterprise solutions.

### SUMMARY OF THE INVENTION

As the AI agents proliferate within the enterprise computing environments, the agents are increasingly deployed in safety-critical domains where trust, transparency, and the implementation of appropriate guardrails are important. Despite their growing importance, the agentic ecosystem suffers from a lack of evaluation metrics that are specifically designed for AI agents. In particular, conventional evaluation systems and techniques fail to provide a comprehensive combined score that accounts for all dimensions of agent performance, ranging from action-taking to policy alignment. Traditional evaluation methods developed for single large language model (LLM) systems are incapable of measuring the operational and outcome-based dimensions of AI agents, since such agents are inherently action-taking and interactive in nature. Current evaluation metrics are too limited and focus only on a narrow subset of outcome-based attributes or are incapable of addressing operational and human-collaboration aspects. At present, no metric exists that is both comprehensive and real-time, such that instant feedback may be provided to the end user after each AI agent run, while also offering aggregate insights across the lifecycle of the agent.

The present invention is directed to an agent evaluation system for determining the performance of AI agents in an enterprise computing environment. The agent evaluation system can employ an agent scoring unit that can be configured to determine a total agent evaluation score associated with the AI agents that are deployed or used in the enterprise computing environment, and based on the evaluation scores, can perform an AI based intervention. The total agent evaluation score can be determined based on the evaluation scores associated with a number of specific categories associated with operational behavior and trustworthiness of the AI agent. More specifically, the agent scoring unit can employ a scoring logic framework that generates individual category evaluation scores that are used to determine the total agent evaluation score for the agents. More specifically, the agent scoring unit can calculate the total agent evaluation score as a weighted aggregate of the individual category evaluation scores based on one or more weighting factors. The system also contemplates employing an agent selection unit that is configured to select the agents based on predefined selection criteria, including the total agent selection score.

The total agent evaluation score serves as a compact representation of an agent's overall suitability for deployment in the enterprise computing environment. The total agent evaluation score can be used by the agent selection unit to determine which agents are most appropriate for activation in the enterprise computing environment. The agent selection unit can compare the total agent evaluation scores of available agents, evaluate them against predefined selection criteria (e.g., threshold scores), and determine whether to deploy an existing agent, instantiate a new agent configured for a selected task, or reconfigure one or more agents based on their evaluated strengths based on score and current system conditions.

Further, The use of category evaluation scores ensures that agent selection decisions are multi-dimensional and context-aware, allowing the agent evaluation system to go beyond simplistic or single-metric leaderboard type of rankings. For example, an agent with a high total score driven primarily by tool precision and computational efficiency can be selected for an automated data processing task, while another agent with high scores in interpretability and collaboration may be better suited for user-facing applications. In cases requiring multiple specialized competencies, the agent selection unit can construct multi-agent teams by selecting agents with complementary category score profiles. By structuring agent evaluation around modular category scores and combining them into a total agent evaluation score, the agent scoring unit and the agent selection unit enable flexible and performance-driven agent deployment strategies.

In certain embodiments, the agent evaluation system can provide proof of verification, provenance, and audit trail functionality. Specifically, the a total agent evaluation score is not only traceable to the agent itself, but can also be decomposed into evaluations for constituent components such as tools, planners, or other sub-systems, thereby enabling a comprehensive trace and audit trail for the entire agent execution run. The framework further incorporates a comprehensive, metric-based structure comprising five categories of metrics, which collectively address operational dimensions (i.e., how the agent is acting), outcome-based dimensions (i.e., what the agent has produced), and explanatory dimensions (i.e., why the agent behaved in a particular manner). These metrics are designed to be universally applicable across agents, ranging from single-task, narrowly scoped agents to fully autonomous, multi-agent systems. The metrics can be consolidated into a single output score (e.g., the total agent evaluation score), which represents an overall performance measure of the agent. Such metrics may also be embedded into agent-to-agent communication protocols to facilitate interoperable performance signaling. The agent evaluation system supports both real-time and lifecycle-oriented evaluations, wherein the total agent evaluation score can be computed during a given execution run of the agent (online) or aggregated across multiple runs to track performance progression throughout the agent's lifecycle (offline).

To ensure objectivity, many sub-metrics underlying the total agent evaluation score can be derived from a hybrid approach that employs large language model (LLM)-based judges in combination with heuristic evaluations, with the option of customization through fine-tuning and/or prompt engineering. Certain sub-metrics may also be determined through ensemble-based validation, wherein multiple independent methods are applied to compute a given metric, and the results are aggregated to provide the most reliable evidence for that score. This ensemble approach improves stability and overall score quality. Additionally, some metrics are configured with corresponding natural language explanations to provide transparency and interpretability of scoring outcomes.

The present invention is directed to a computer-implemented artificial intelligence (AI) agent evaluation system for evaluating an AI agent associated with an enterprise computing environment. The system can include an agent aggregation unit for aggregating together a plurality of AI agents associated with the enterprise computing environment, and an agent evaluation unit for evaluating a selected AI agent of the plurality of AI agents using evaluation data, where the evaluation data includes operational behavior data and trustworthiness data. The agent evaluation unit can include an agent scoring unit for determining a total agent evaluation score for the selected AI agent and an intervention unit. The total agent evaluation score can be determined from a plurality of category evaluation scores from a plurality of agent specific categories, wherein each of the plurality of agent specific categories has associated therewith a category evaluation score, and wherein the plurality of agent specific categories includes categories associated with the operational behavior and the trustworthiness of the selected AI agent. The intervention unit can be configured for automatically initiating an AI-based intervention in the enterprise computing environment in response to the total agent evaluation score of the selected AI agent received from the agent scoring unit. The agent evaluation unit is configured to enhance computational efficiency and decision accuracy within the enterprise computing environment by dynamically adapting agent tasking and deployment based on the total agent evaluation score.

The agent evaluation unit can further include an agent selection unit configured to select, for assignment to a task, one or more of the AI agents of the plurality of AI agents having the total agent evaluation score that satisfies one or more predefined selection criteria. The agent evaluation unit can enable dynamic and automated control of agent deployment based on the total agent evaluation score, thereby improving operational efficiency of the enterprise computing environment and decision accuracy of the selected AI agent. The plurality of agent specific categories includes a planning accuracy category, a tool precision category, a knowledge reliability category, a safety and compliance category, and a human collaboration category. The agent categories can also be categorized into an operational behavior category and a trustworthiness category. For example, the agent specific categories including the safety and compliance category and the knowledge reliability category can be categorized as trustworthiness categories. Similarly, the agent specific categories including the planning accuracy category, the tool precision category, and the human collaboration category can be categorized as operational behavior categories.

According to one embodiment, the agent scoring unit can be configured to employ a scoring logic framework that assigns a selected weight to each of the agent specific categories. The agent scoring unit can also be configured to automatically and dynamically adjust the weights assigned to each agent specific category based on one or more weighting factors and an operational context of the AI agent. Specifically, the agent scoring unit can employ a weighted aggregation technique to determine the total agent evaluation score based on the category evaluation scores of the plurality of agent specific categories. Alternatively, the agent scoring unit can employ an unweighted technique that determines an arithmetic mean of the category evaluation scores. The agent scoring unit can apply the scoring logic framework such that the category evaluation score associated with the planning category is determined by analyzing a correct number of steps executed by the AI agent and then dividing the correct number of steps by a total number of steps; the category evaluation score associated with the tool precision category is determined by comparing a number of correct tool invocations performed by the AI agent to a total number of tool invocations attempted by the AI agent; the category evaluation score associated with the knowledge reliability category is determined based on one or more measurable indicators including a staleness check and a contradiction rate; the category evaluation score associated with the safety and compliance category is determined by determining a proportion of interactions that occur without triggering a safety incident; and the category evaluation score associated with the human collaboration category is determined based on one or more of an escalation accuracy, a feedback reinforcement effectiveness, an oversight compliance, and a transparency quality. Further, the intervention unit can automatically perform an AI-based intervention when the total evaluation score is below a selected threshold, and wherein the AI-based intervention includes an agent related corrective action.

The present invention is also directed to a computer-implemented method for evaluating an AI agent associated with an enterprise computing environment. The method can include aggregating, with an agent aggregation unit, a plurality of AI agents associated with the enterprise computing environment, and evaluating, with an agent evaluation unit, a selected AI agent of the plurality of AI agents using evaluation data, wherein the evaluation data includes operational behavior data and trustworthiness data. The agent evaluation unit can be configured to determine, with an agent scoring unit, a total agent evaluation score for the selected AI agent, where the total agent evaluation score is determined from a plurality of category evaluation scores from a plurality of agent specific categories, and wherein each of the plurality of agent specific categories has associated therewith a category evaluation score and the plurality of agent specific categories includes categories associated with the operational behavior and the trustworthiness of the selected AI agent; and automatically initiating, with an intervention unit, an AI-based intervention in the enterprise computing environment in response to the total agent evaluation score of the selected AI agent received from the agent scoring unit. The agent evaluation unit can be configured to enhance computational efficiency and decision accuracy within the enterprise computing environment by dynamically adapting agent tasking and deployment based on the total agent evaluation score.

The method can also include selecting, with an agent selection unit of the agent evaluation unit, for assignment to a task, one or more of the AI agents of the plurality of AI agents having the total agent evaluation score that satisfies one or more predefined selection criteria. The agent evaluation unit can enable dynamic and automated control of agent deployment based on the total agent evaluation score, thereby improving operational efficiency of the enterprise computing environment and decision accuracy of the selected AI agent.

The method can also include employing a scoring logic framework for assigning a selected weight to each of the agent specific categories, and automatically and dynamically adjusting the weights assigned to each agent specific category based on one or more weighting factors and an operational context of the AI agent. In this regard, the scoring logic framework can apply a weighted aggregation technique to determine the total agent evaluation score based on the category evaluation scores of the plurality of agent specific categories. Further, the scoring logic framework can be applied such that the category evaluation score associated with the planning category is determined by analyzing a correct number of steps executed by the AI agent and then dividing the correct number of steps by a total number of steps; the category evaluation score associated with the tool precision category is determined by comparing a number of correct tool invocations performed by the AI agent to a total number of tool invocations attempted by the AI agent; the category evaluation score associated with the knowledge reliability category is determined based on one or more measurable indicators including a staleness check and a contradiction rate; the category evaluation score associated with the safety and compliance category is determined by determining a proportion of interactions that occur without triggering a safety incident; and the category evaluation score associated with the human collaboration category is determined based on one or more of an escalation accuracy, a feedback reinforcement effectiveness, an oversight compliance, and a transparency quality. The method still further includes automatically performing, with the intervention unit, an AI-based intervention when the total evaluation score is below a selected threshold, and wherein the AI-based intervention includes an agent related corrective action.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of the model verification system according to the teachings of the present invention.

FIG. 2 is a schematic block diagram of the multi-factorial cohort selection unit of the cohort determination unit of FIG. 1 according to the teachings of the present invention.

FIG. 3 is an example of a model trust card that can be employed to set forth selected information associated with trusted models verified and evaluated by the system of FIG. 1 according to the teachings of the present invention.

FIG. 4 is a schematic block diagram of the agent evaluation system according to the teachings of the present invention.

FIG. 5 is a schematic block diagram of the agent evaluation unit of the agent evaluation system of FIG. 4 according to the teachings of the present invention.

### DETAILED DESCRIPTION OF THE INVENTION

The present invention relates to the technological field of artificial intelligence (AI) and machine learning (ML) systems, and more particularly to systems and methods for the verification and evaluation of machine learning models, including generative language models and associated generative artificial intelligence systems. The models and systems are increasingly deployed in enterprise and mission-critical applications where responsible operation, accuracy, compliance, and trustworthiness are required. Ensuring the reliability of the models and systems under diverse conditions presents significant technical challenges, especially in domains governed by legal, regulatory, or safety constraints.

Conventional model verification techniques often rely on centralized, opaque, and biased evaluation processes. These conventional approaches lack the ability to adapt to complex real-world conditions, such as geographic variation, contextual relevance, and jurisdiction-specific requirements. Moreover, conventional systems frequently involve verification performed or overseen by the same entities responsible for developing the models, introducing conflicts of interest and limiting transparency.

The present invention provides a technological improvement to the field of AI model and system verification through a system and method that implements a blinded, multi-party verification process for evaluating the performance and behavior of machine learning models. In particular, the system of the present invention enables dynamic, continuous, and reproducible verification using independently selected raters or cohorts who are blinded from each other and from the parties being evaluated. Verification participants may be selected based on a range of multi-factorial attributes, including domain expertise, geographic location, primary language, contextual knowledge, industry background, and regulatory familiarity. This flexible architecture allows for objective, domain- and context-specific evaluation of generative models under diverse operational scenarios.

The blinded, multi-party design helps prevent collusion, bias, and undue influence, improving trust in the verification and subsequent evaluation outcomes and addressing shortcomings of traditional model verification and assessment systems. The system of the present invention further provides for transparency in how verification is conducted, offering traceable, auditable mechanisms for model verification in environments where trust and compliance are essential. By enabling reproducible, unbiased evaluations of machine learning models in real-world contexts, the present invention enhances the functionality, reliability, and accountability of AI systems, and provides a concrete and practical application of machine learning technology. Accordingly, the present invention advances the underlying technology by solving specific technical problems in model verification and supports trustworthy deployment in safety-sensitive domains.

The present invention thus relates to the field of model and system verification and evaluation, addressing common issues such as the complexity of conventional verification processes, which involve diverse factors such as geolocation and context, and the need to adhere to local regulations. As noted herein, traditional approaches often fail to account for the complexity of real-world artificial intelligence or machine learning systems that operate under diverse and changing conditions. Without sufficient transparency into verification and evaluation methodologies and participants, conventional systems have difficulty assessing verification results, compromising trust in model selection and performance. Additional concerns include potential conflicts of interest, as parties responsible for model development oftentimes oversee verification of the model, further jeopardizing trust in the model results.

The present invention provides improvements to this field of technology by offering a system and model verification system and associated method that employs a blinded multi-party verification technique to verify generative language models and generative artificial intelligence systems. The generative language models require verification to ensure that the models operate responsibly and achieve intended outcomes. The approach of the present invention can include a dynamic, multi-stakeholder blinded verification process for the continuous verification and evaluation of machine learning models, such as generative language models, and the systems that use them. The goal of the present invention is to promote unbiased, reproducible assessments by preventing potential biases between evaluators and the subjects of evaluation. The method also accommodates testing of the machine learning systems and models under diverse operating conditions to establish trust in the underlying systems that employ the models.

The verification system and method of the present can include selecting verification participants (e.g., independent reviewers or evaluators) and usage participants based on multi-factorial attributes, including industry domain, skills, locale, expertise, primary language, years of experience, and the like. The present invention also considers the context, geolocation, circumstances, geo-specific regulations, and the environment in which the models run. The blinded review process hides reviewer or evaluator identities and details from participants so as to promote an independent and unbiased review of the models. By employing multiple blinded parties during the verification process, the present invention improves upon conventional model validation and verification processes by preventing bias and influence from any one source, thereby enhancing trust in the field of technology.

As used herein, the term “enterprise” is intended to include all or a portion of a company, a structure or a collection of structures, facility, business, company, firm, venture, joint venture, partnership, operation, organization, concern, establishment, consortium, cooperative, franchise, or group or any size. Further, the term is intended to include an individual or group of individuals, or a device or equipment of any type.

As used herein, the term “source data” can include any type of data from any suitable source that would benefit from being converted into a more usable form or should be acted upon by the system of the present invention. The source data can include, for example, financial related data and non-financial related data. The source data can be in hard copy or written form, such as in printed documents, or can be in digital file formats, such as in portable document format (PDFs), word processing file formats such as WORD documents, as well as other file formats including hypertext markup language (HTML) file formats and the like. It is well known in the art that the hard copies can be digitized, and the relevant data extracted therefrom.

As used herein, the term “enrich,” “enriched” or “enriching” is intended to include the ability to ingest, integrate, augment, improve and/or enhance data by supplementing missing or incomplete data, correcting inaccurate data, adding additional data, or processing the data using known techniques, such as with artificial intelligence, machine learning and risk modelling techniques, and then applying logic and structure to the data so as to curate, correct and/or clean the data. The term enrich can also include the ability to correlate factors to the data so as to generate or create meaningful insights and conclusions based on the data, including environmental and financial data. In the context of prompts, the prompts can be enriched by adding more context, detail, or specificity in order to better guide or instruct a machine learning model a conversation or direct the output of the model towards a desired outcome. This can involve providing additional information, constraints, examples, or specifications that help the model generate a more relevant and tailored response.

As used herein, the term “machine learning” or “machine learning model” or “model”, whether in singular or plural form, is intended to mean or refer to the application of one or more software application based techniques that process and analyze data to identify patterns and to generate inferences, predictions, classifications, decisions, and/or recommendations based on the patterns in the data. The machine learning techniques may include a variety of models and algorithms, such as supervised learning, unsupervised learning, reinforcement learning, semi-supervised learning, deep learning, and natural language processing (NLP) techniques, including natural language generation (NLG) and generative language models. The machine learning models are typically trained using training data. The training data is used to optimize the parameters of the model, such as the weights in a neural network. As such, the better the training data, the more accurate and effective the machine learning model can be. In the case of supervised learning, the training data includes labeled examples (i.e., input-output pairs) that allow the model to learn a mapping from inputs to target outputs. Common tasks performed by supervised learning models include classification and regression. Unsupervised learning models are trained on unlabeled data and are configured to identify hidden patterns, structures, or groupings in the data. Common unsupervised learning tasks include clustering and dimensionality reduction. Semi-supervised learning techniques combine elements of supervised and unsupervised learning by utilizing a small amount of labeled data in conjunction with a larger volume of unlabeled data to improve model performance. The semi-supervised learning models combine elements of both supervised and unsupervised learning models, utilizing limited labeled data alongside larger amounts of unlabeled data to improve model performance. Reinforcement learning involves training an agent to take sequential actions within an environment to maximize a reward signal. The agent learns through trial and error by receiving feedback in the form of rewards or penalties based on its actions. Deep learning is a subfield of machine learning that utilizes neural networks with multiple layers to automatically learn hierarchical feature representations from data. A neural network includes a plurality of interconnected nodes (or “neurons”) organized into layers, where each connection is associated with a weight that determines the strength of the signal passed between neurons. The weights are updated during training to minimize prediction error and improve performance. By adjusting these weights based on input data and desired outcomes, neural networks can learn complex patterns and relationships within the data. Examples of neural networks used in deep learning include feedforward neural networks (FNNs), convolutional neural networks (CNNs), recurrent neural networks (RNNs), long short-term memory (LSTM) networks, gated recurrent units (GRUs), autoencoders, generative adversarial networks (GANs), and transformer-based architectures. Transformer-based models, including large language models (LLMs), are configured to process and generate human language by learning contextual relationships between tokens in a sequence. These models are typically pre-trained on large corpora of text using self-supervised learning techniques and can perform a wide range of language-related tasks, such as text generation, translation, summarization, question answering, and sentiment analysis. The large language models (LLMs) may include, or be implemented as, generative artificial intelligence (AI) models that are capable of generating coherent and contextually appropriate text responses based on input prompts. LLMs can be configured to understand and generate human language by learning patterns and relationships from large datasets. These models may utilize deep learning techniques, particularly transformer architectures, to process and generate text. LLMs can be pre-trained on massive corpora of textual data using self-supervised learning techniques and may perform tasks such as text generation, language translation, summarization, sentiment analysis, question answering, and other natural language processing tasks.

A transfer learning model can involve training a model on a first task and subsequently applying the learned parameters or representations to a second, related task, thereby enhancing training efficiency and model performance. An ensemble learning model can combine the outputs of multiple individual models to improve overall predictive accuracy. Common ensemble techniques include bagging, boosting, and stacking. An online learning model can be incrementally updated as new data becomes available, making such models suitable for real-time or dynamic environments. An instance-based learning model can generate predictions based on similarity measures between new input instances and previously observed training instances.

The machine-learning processes described herein may be utilized to generate machine-learning models. As used herein, a machine-learning model refers to a mathematical representation of a relationship between one or more inputs and corresponding outputs, generated using any machine-learning technique, including without limitation any of the processes described above, and stored in memory. Once created, a machine-learning model may receive one or more input values and produce a corresponding output based on the learned relationship derived during training. For example, and without limitation, a linear regression model generated using a linear regression algorithm may compute a linear combination of input features using coefficients learned during training to generate an output value. As a further non-limiting example, a machine-learning model may be implemented as an artificial neural network, such as a convolutional neural network (CNN), comprising an input layer of nodes, one or more hidden (intermediate) layers, and an output layer of nodes. Connections between nodes may be established and weighted through a training process in which data from a training dataset are applied to the input layer. A training algorithm—such as Levenberg-Marquardt, conjugate gradient, simulated annealing, or other optimization algorithms—may be used to iteratively adjust the connection weights between nodes in adjacent layers to minimize prediction error and produce desired outputs at the output layer. This type of approach may be referred to as deep learning.

As used herein, the term “generative model,” “generative AI model” or “generative language model”, whether in singular or plural form, is intended to mean or refer to a category of machine learning models configured to generate new outputs based on data on which the models have been trained. Generative models may produce new content in various modalities, including text, images, audio, code, simulations, and the like. Generative language models specifically focus on generating natural language text and are typically based on deep learning neural networks, such as large language models (LLMs) employing transformer architectures. These models learn patterns and relationships within training data and generate new language content based on the learned representations. Generative models may include, without limitation, generative adversarial networks (GANs), which consist of two neural networks trained adversarially to generate realistic images, audio, or other data types; variational autoencoders (VAEs), which learn latent representations of data for generation tasks; and deep convolutional GANs (DCGANs), which use convolutional layers for generating realistic images and textures. For language generation tasks, recurrent neural networks (RNNs), including variants such as long short-term memory (LSTM) networks and gated recurrent units (GRUs), have historically been employed to generate sequential data by predicting the likelihood of each word based on preceding context. More recently, transformer-based architectures have become prevalent for natural language processing and generation, as they can effectively attend to various parts of input sequences and learn complex dependencies to produce coherent and contextually relevant text. The generative AI models described herein can be trained on diverse types of training data, including text, images, and audio, and can be applied to a variety of applications such as image and video synthesis, natural language generation, music composition, code generation, and other content creation tasks.

In the present disclosure, data used to train a machine learning model can include data containing correlations that a machine learning process or technique may utilize to model relationships between two or more types or categories of data elements (“training data”). For example, and without limitation, the training data may comprise a plurality of data entries, each entry representing a set of data elements that were recorded, received, and/or generated together. The data elements may be correlated by shared co-occurrence within a data entry, proximity within the data, or other relationships. Multiple data entries within the training data may exhibit one or more trends or patterns in correlations between categories or types of data elements. For instance, and without limitation, a higher value of a first data element belonging to a first category or type of data element may tend to correlate with a higher value of a second data element belonging to a second category or type of data element, indicating a possible proportional or other mathematical relationship linking values across categories. Multiple categories of data elements may be related in the training data according to various correlations, which may indicate causative, associative, and/or predictive links between categories of data elements. These correlations may be modeled as mathematical or statistical relationships by the machine learning processes described herein. The training data may be formatted and/or organized by categories of data elements, for example by associating data elements with one or more descriptors corresponding to categories. As a non-limiting example, training data may include data entered in standardized forms by persons or processes, such that entry of a given data element in a given field within a form may be mapped or correlated to one or more category descriptors. Elements in the training data may be linked to descriptors of categories or types by tags, tokens, or other data elements. For example, and without limitation, training data may be provided in fixed-length formats, formats linking positions of data to categories such as comma-separated value (CSV) formats, and/or self-describing formats such as extensible markup language (XML), enabling processes or devices to detect categories of data.

Alternatively, or additionally, the training data may include one or more data elements that are not categorized, that is, the training data may not be formatted or contain descriptors for some elements of data. Machine-learning models or algorithms and/or other processes may sort the training data according to one or more categorizations using, for instance, natural language processing algorithms, tokenization, detection of correlated values in raw data and the like. The categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name or other types of data may be identified by reference to a list, dictionary, or other compendium of terms, permitting ad-hoc categorization by machine-learning algorithms, and/or automated association of data in the data entry with descriptors or into a given format. The ability to categorize data entries automatically may enable the same training data to be made applicable for two or more distinct machine-learning algorithms as described in further detail below. Training data used by an electronic device may correlate any input data as described in this disclosure to any output data as described in this disclosure.

As used herein, the terms “AI agent,” “artificial intelligence agent,” or simply “agent” refer to a software-based system or program configured to perceive information from one or more environments, interpret or analyze such information, make determinations or decisions based thereon, and perform actions in an autonomous or semi-autonomous manner to achieve one or more defined objectives. The AI agent can incorporate or interface with one or more machine learning models, such as generative language models, neural networks, decision trees, or other statistical or computational methods, that are configured to process input data, identify patterns, and generate outputs or predictions based on learned representations. In various embodiments, the AI agent is further capable of adapting its behavior over time through one or more learning processes that do not require explicit reprogramming. Such learning processes may include supervised learning based on labeled training data, reinforcement learning in which the agent receives feedback (e.g., rewards or penalties) in response to its actions, or unsupervised learning in which the agent autonomously identifies structures or patterns within unlabeled data. The agent can thereby improve its performance, accuracy, or decision-making capabilities through iterative interaction with data and the surrounding environment. In some embodiments, the AI agent can operate within a feedback loop, wherein the agent's actions influence the environment, and the resulting environmental response provides additional input or feedback used to refine subsequent behavior or decisions by the agent. The AI agent may further be configured to interact with one or more human users, external systems, or other agents, either cooperatively or competitively, depending on the operational context. The design and implementation of the AI agent can vary by application, but generally encompass components for perception, inference, decision-making, action execution, and learning, each of which may be implemented using modular software components or computational architectures.

As used herein, the term “data object” can refer to a location or region of storage that contains a collection of attributes or groups of values that function as an aspect, characteristic, quality, entity, or descriptor of the data object. As such, a data object can be a collection of one or more data points that create meaning as a whole. One example of a data object is a data table, but a data object can also be data arrays, pointers, records, files, sets, and scalar type of data.

As used herein, the term “attribute” or “data attribute” is generally intended to mean or refer to the characteristic, properties or data that describes as aspect of a data object or other data. The attribute can hence refer to a quality or characteristic that defines a person, group, or data objects. The properties can define the type of data entity. The attributes can include a naming attribute, a descriptive attribute, and/or a referential attribute. The naming attribute can name an instance of a data object. The descriptive attribute can be used to describe the characteristics or features or the relationship with the data object. The referential attribute can be used to formalize binary and associative relationships and in referring to another instance of the attribute or data object stored at another location (e.g., in another table). When used in connection with prompts for use with a generative language model, the term is further defined below.

The term “application” or “software application” or “program” as used herein is intended to include or designate any type of procedural software application and associated software code which can be called or can call other such procedural calls or that can communicate with a user interface or access a data store. The software application can also include called functions, procedures, and/or methods.

The term “graphical user interface” or “user interface” as used herein refers to any software application or program, which is used to present data to an operator or end user via any selected hardware device, including a display screen, or which is used to acquire data from an operator or end user for display on the display screen. The interface can be a series or system of interactive visual components that can be executed by suitable software. The user interface can hence include screens, windows, frames, panes, forms, reports, pages, buttons, icons, objects, menus, tab elements, and other types of graphical elements that convey or display information, execute commands, and represent actions that can be taken by the user. The objects can remain static or can change or vary when the user interacts with them.

As used herein, the term “electronic device” can include servers, controllers, processors, computers, tablets, storage devices, databases, memory elements and the like.

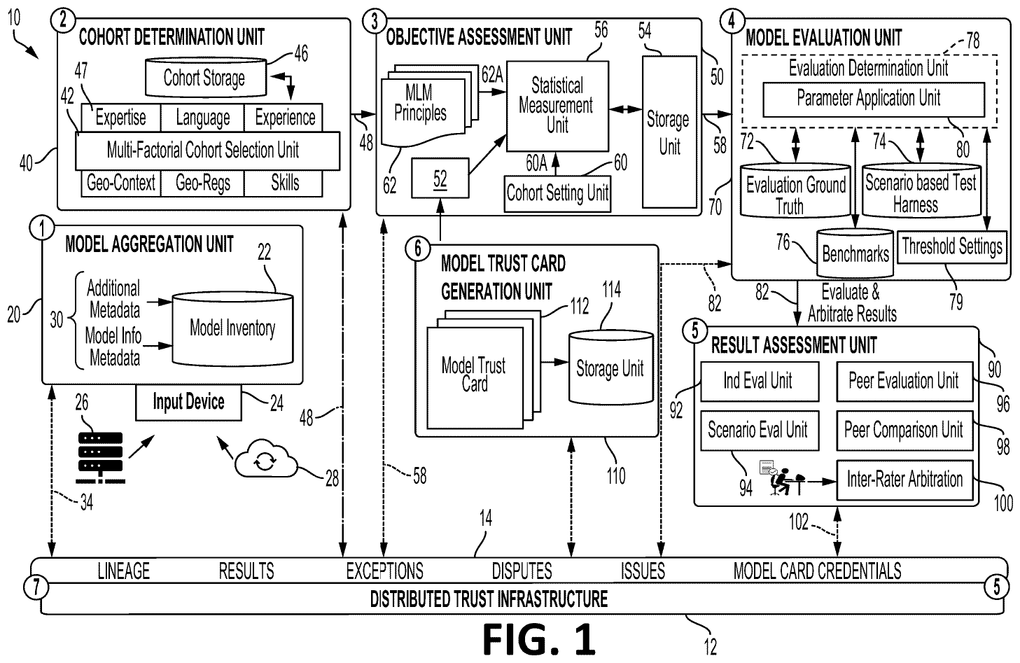

The model verification system of the present invention is shown for example in FIG. 1 The illustrated model verification system 10 includes a distributed trust infrastructure 12 that can include a distributed ledger-like blockchain. The digital trust infrastructure 12 can secure in a trusted and verifiable manner data that is received from one or more system components, such as for example from the model inventory, evaluator data, objective configurator, model evaluator, assessment results, model system cards, and the like. The data once secured in the distributed trust infrastructure 12 is resistant to change and is easily verifiable. The data secured in the digital trust infrastructure 12 can be open for inspection or access to the data and can be restricted in known ways. The distributed trust infrastructure 12 can employ a blockchain, thus enabling the model verification system to cryptographically verify and store the logic and structure applied to the stored data so as to curate the data. The stored and verifiable data can also be used for subsequent reporting and analysis.

In a blockchain, as is known, the original data or the processed data can be stored in a series of batches or blocks that include, among other things, a time stamp, a hash value of the data stored in the block, a copy of the hash value from the previous block, as well as other types of information, including for example the origins of the data. The blockchain is shared with a plurality of nodes in a blockchain network in a decentralized manner with no intermediaries. Since many copies of the blockchain exist across the blockchain network, the veracity of the data in the blocks can be easily tracked and verified. Each instance of new data from the source data or data and models and techniques employed by the system can be stored in a block on the blockchain. The blockchain thus functions as a decentralized or distributed ledger having data associated with each block that can be subsequently reviewed and/or processed. The data in the blockchain can be tracked, traced, and presented chronologically in a cryptographically verified ledger format of the blockchain to each participant of the blockchain. As such, the blockchain can provide an audit trail corresponding to all of the data in the blocks, and thus can determine who interacted with the data and when, as well as the sources of the data and any actions taken in response to the data. According to one embodiment, each node of the blockchain network can include one or more computer servers which provides processing capability and memory storage. Any changes made by any of the nodes to a corresponding block in the blockchain are automatically reflected in every other ledger in the blockchain. As such, with the distributed ledger format in the blockchain, provenance can be provided with the dissemination of identical copies of the ledger, which has cryptographic proof of its validity, to each of the nodes in the network. Consequently, all of the various types of data (e.g., original data, enriched data, the software and models and techniques employed to enrich the data, and the insights and recommendations generated therefrom) can be stored in the blockchain, and the blockchain can be used to verify, prove and create an immutable record of the data, various rule based models and techniques, and machine learning models and techniques, as well as to track users accessing the data and any associated insights generated by the models.

The blockchain can employ a smart contract 14. As used herein, the term “smart contract” is intended to mean or refer to executable computer code, logic, or protocols that are stored on the blockchain and enable the system 10 to generate data for storage in the blockchain according to a predefined set of rules or upon the occurrence of predefined conditions. Accordingly, a smart contract can process incoming data that satisfies the predefined rules and generate new information or facts that are appended to the ledger of the blockchain. The smart contract thus enables enterprises to transact business with each other according to a common set of defined terms, data, rules, concept definitions, and processes. Collectively, the smart contracts define the business model and govern all interactions within or between enterprises or parties in executable code. Applications invoke a smart contract to generate transactions that are recorded on the ledger. Specifically, the smart contract implements governance rules for any type of business object, allowing such rules to be automatically enforced upon execution of the smart contract. For example, a smart contract can ensure that a new car delivery is made within a specified timeframe or that funds are released according to prearranged terms, thereby improving the flow of goods or capital, respectively. Notably, execution of a smart contract is typically more efficient than manual human business processes. Smart contracts can be grouped together to form a chaincode, which is used by administrators to package related smart contracts for deployment. Generally, a smart contract defines the transaction logic controlling the lifecycle of a business object contained in the blockchain's world state. Chaincode governs how one or more smart contracts are packaged and deployed to the blockchain. When chaincode is deployed, all smart contracts within it become available to applications. An example of a system suitable for generating or employing a smart contract in connection with documents is disclosed in U.S. Pat. No. 10,528,890, assigned to the assignee hereof, the contents of which are herein incorporated by reference.

At a basic level, the blockchain immutably records transactions which update states in a ledger. The smart contract can programmatically access two distinct pieces of the blockchain ledger, namely, a blockchain, which immutably records the history of all transactions, and a world state that holds a cache of the current value of these states. The blockchain is an immutable ledger of all transactions that have occurred, where every transaction is reflected as an object recorded to the blockchain in a discrete block. Each block of the chain contains an object key. Multiple transactions with the same object key can occur. The world state is in essence a database that sits on the blockchain and holds current values for a given object key. The world state changes over time as new transactions reference the same object key. As a result, the blockchain determines the world state, and the ledger is comprised of both the blockchain and the world state. The smart contracts primarily put, get and delete states in the world state, and can also query the immutable blockchain record of transactions. The “get” typically represents a query to retrieve information about the current state of a business object. The “put” typically creates a new business object or modifies an existing one in the ledger world state, and the “delete” typically represents the removal of a business object from the current state of the ledger, but not the history of the ledger.

Further, when the smart contract executes, the contract runs on a peer node that forms part of the blockchain network. The smart contract takes a set of input parameters called the transaction proposal and uses them in combination with program logic to read from and write to the ledger. Changes to the world state are captured as a transaction proposal response, which contains a read-write set with both the states that have been read, and the new states that are to be written if the transaction is valid. The world state is not updated when the smart contract is executed.

A generative artificial intelligence (AI) system refers generally to a computing system configured to generate content based on learned patterns in data. In particular, such systems can include one or more generative models, including but not limited to generative language models, that are trained on large corpora of structured or unstructured data to produce novel output content in response to user input or predefined prompts. In various embodiments, a generative AI system includes a machine learning model trained to predict and generate sequences, such as natural language text, by estimating the conditional probability of the next token (e.g., word, sub-word unit, or character) given a preceding sequence of tokens. The generative language model may be implemented using a neural network architecture, such as a transformer-based architecture, and may be trained using supervised learning, unsupervised learning, reinforcement learning, or combinations thereof. Upon receiving an input prompt, the system processes the input through the trained model to generate output content that is contextually relevant and coherent with the input. Output content may include, for example, natural language text, computer code, images, audio, or other forms of synthetic media. The generated output can be used in a variety of applications, including content generation, summarization, code completion, dialog systems, creative writing, automated report generation, and more. In some embodiments, the generative AI system further includes pre-processing and post-processing modules to refine the input and/or output, as well as filtering mechanisms or control modules to ensure the safety, relevance, or domain-specific suitability of the generated content. The generative AI system may be implemented on a single computing device or distributed across a network of servers, and may support user interaction through an application programming interface (API), graphical user interface (GUI), or other input/output interface. According to one embodiment, the verification system 10 of the present invention can be a generative artificial intelligence system.

The illustrated system or model verification system 10 can include a model aggregation unit 20 for aggregating together the machine learning models associated with the enterprise or to be imported into the enterprise. The model aggregation unit 20 can employ suitable software applications for retrieving the machine learning models and for storing the machine learning models in a suitable storage element 22, such as a database. The database thus serves as an inventory for the machine learning models associated with the enterprise. The model aggregation unit 16 can also include an input device 24 for importing or uploading the machine learning models into the database. The input device 24 can be coupled to one or more electronic devices 26 that has the machine learning model stored therein for importing the machine learning models into the model aggregation unit 16. Similarly, the input device 24 can be coupled to one or more electronic networks 28 that are suitable for importing the machine learning models into the model aggregation unit 20 therefrom.

The machine learning models stored in the storage unit 22 can also include metadata 30. As used herein, the term “metadata” is intended to mean data that describes data. Specifically, metadata can refer to information that describes and provides context to a data object, such as a machine learning model. The information can include but is not limited to details about the structure, components, and parameters of the machine learning model, the data and processes used to train the model, reproduce the model, manage the model, performance metrics, versioning information, deployment configurations, verification related information, and the like. The metadata facilitates understanding, utilization, and management of the machine learning model by providing contextual information that supports development, deployment, and maintenance of the model. In certain implementations, metadata associated with a machine learning model can include various types of information relevant to the structure, training, evaluation, deployment, and versioning of the model. For example, model architecture metadata may include the type of model and hyperparameter-related information such as learning rate, batch size, number of training epochs, and similar configuration details. Training-related metadata may include a description of the dataset used for training, data preprocessing steps such as normalization and augmentation, and information regarding how the dataset was partitioned into training, validation, and test subsets. Metadata relating to the training process may include the duration of training, computational resources utilized, training loss and model accuracy over time, and the optimization algorithm employed, such as Adam or stochastic gradient descent (SGD). Evaluation-related metadata may include performance metrics such as accuracy, precision, recall, and F1 score, as well as confusion matrices, evaluation plots, and results from cross-validation procedures. Versioning metadata may include a model version number or identifier, the version numbers of machine learning libraries and frameworks used (e.g., TensorFlow, PyTorch), and version information associated with source code repositories, such as a Git commit hash. Deployment metadata may include details of the deployment environment (e.g., production or staging), information relating to model endpoints or application programming interfaces (APIs), and any post-processing steps applied to outputs during inference. Additional metadata may include provenance and lineage information, such as the name of the model's author or creator, the date of creation and last modification, and the origin of the model, for example, whether it was pre-trained or transferred from another task. Metadata may also include configuration-related information, such as configuration files specifying the model setup, training scripts, and associated parameters. Such metadata may be used, for example, to track, audit, reproduce, or manage machine learning models within a system or across different environments.

The model aggregation unit 20 can also add any of the foregoing types of metadata or other types of metadata to the models, or associated with the models, stored in the storage unit 22. The model information 34 stored in the storage unit 22 can be conveyed to and stored in the distributed trust infrastructure 12. The metadata about the systems and models, including knowledge assistants, agents, and generative language models, can be stored in a machine learning model inventory and can play a role in the model verification lifecycle. For example, the machine learning model inventory can store detailed metadata about the model's training data, architecture, hyperparameters, or the entire training process, allowing auditors and verifiers to understand the model's origins, assumptions, and potential biases. This provides for model traceability and provenance. The metadata can also include information about the model architecture, training data, hyperparameters, random seeds, and the complete training pipeline environment enables faithful reproduction of the model for independent verification and validation, thus ensuring reproducibility of model behavior and performance. The metadata can also include historical model data to monitor the performance of the model and detect any drift or degradation of the model, thus triggering the need for re-verification or model updates. The metadata can also include data about the model's compliance with regulations, standards, and ethical guidelines, thus ensuring that the model meets necessary requirements for deployment in specific domains or jurisdictions. The metadata can also include data about potential risks, failure modes, and mitigation strategies that inform and triggers rigorous testing or additional safeguards. The metadata can further include data about development, deployment, and verification processes to ensure the appropriate stakeholder involvement, promoting transparency and accountability. The machine learning model inventory can serve as a central repository for storing and tracking ongoing verification processes, such as audits, stress tests, or real-world performance monitoring, continuously assessing trustworthiness and identifying areas for improvement.

The model verification system 10 of the present invention can also include a cohort determination unit 40 for allowing the system to automatically determine and select multiple cohorts to verify one or more of the machine learning models aggregated by the model aggregation unit 20. As used herein, the term “cohort”, whether in singular or plural form, is intended to mean or refers to a reviewer, multiple reviewers or evaluators, or a subset of data selected from a larger dataset, wherein the reviewers or the data entries can be defined by one or more shared attributes, features or characteristics. Such cohorts can be used to systematically verify and evaluate the performance, fairness, and robustness of a machine learning model across distinct segments of data. The purpose of determining and selecting cohorts is to verify the performance and behavior of the machine learning model across different segments of the population, ensuring that the model is robust, fair, and generalizes well to various subgroups. The purpose of cohort selection includes ensuring that the model performs well not only on training data but also on new data and mitigates any potential biases that may be present in the machine learning model. By verifying model performance by different blinded cohorts, it is possible to detect if the model is unfairly biased towards or against particular groups. Further, the selection of multiple different cohorts can help assess the robustness of the machine learning model under different conditions. Cohort selection allows for testing the model's stability and reliability as part of the verification process when the model is subjected to data from various segments of the population. Further, the multiple different cohorts can help identify any errors in the model or identify where the model may be underperforming. This can highlight specific areas where the model needs improvement. The cohorts can have one or more attributes in common.

The illustrated cohort determination unit 40 can include a multi-factorial cohort selection unit 42 and a cohort storage unit 46. The cohort storage unit 46 can store a total set of cohorts from which the cohort selection unit 42 can select a subset of cohorts to review and verify the machine learning model or system. The cohort storage unit 46 can also optionally store the subset of cohorts selected from the total set of cohorts by the cohort selection unit 42. The cohort storage unit 46 can further optionally store a total set of cohort attributes that can be employed by the cohort selection unit 42 when determining the subset of cohorts. The illustrated cohort selection unit 42 can select the subset of cohorts from the total set of cohorts based on multiple different cohort attributes from the total set of cohort attributes. As used herein, the term “cohort attribute(s)” is intended to refer to specific characteristics, features, or properties associated with a cohort or that define and distinguish a particular group of data samples used during the verification process of the machine learning model or system. The attributes can encompass the relevant aspects of data, such as demographic information, behavioral patterns, environmental conditions, or any other pertinent variables that are employed when evaluating the performance, accuracy, and robustness of the machine learning model across diverse subsets of the overall dataset. Cohort attributes help ensure that the verification process is comprehensive and that the model performs consistently and equitably across different segments of the data population. The cohorts can share common cohort attributes, such as demographic attributes or characteristics (e.g., age, gender, ethnicity, income level, education, language, skills, experience, or occupation), geographic attributes, health or clinical status attributes (e.g., medical conditions or treatment types), behavioral pattern attribute, skills based attributes, health or clinical status attributes, temporal characteristic attribute (e.g., groups of people defined by specific time periods or events), or any other relevant factors that are pertinent to the problem being addressed by the machine learning model. In certain implementations, verification across multiple cohorts may also facilitate the detection of model errors or underperformance in specific conditions or domains, enabling targeted improvements. Cohort selection further enables the assessment of model robustness, reliability, and stability when subjected to diverse data types or subgroups

According to one optional embodiment, the cohort selection unit 42 can determine the subset of cohort attributes from the total set of cohort attributes that can be used to select the subset of cohorts based on one or more of the machine learning model and/or the cohort attributes provided in selected input data. The selected input data can include, for example, multi-factorial attribute data, contextual attribute data, blind review attribute data, and party or cohort related attribute data. The multi-factorial cohort attribute data can include domain-specific information, including for example information related to industry verticals such as healthcare, finance, technology, and/or education. Additionally, the cohort attribute data may include skill-related information, such as competencies in natural language processing, data analysis, programming, and other domain-specific proficiencies. Locale information, including geographic region (e.g., country, state, urban or rural classification), may also be included. Other data elements may relate to expertise, including years of experience, professional certifications, and publications. Language proficiency and educational background may also be included within this attribute class. The contextual attribute data may include application context data (e.g., enterprise, consumer, or research use cases), geolocation data (e.g., GPS coordinates, city, state/province, or country), circumstantial data (e.g., time of day, day of the week, or environmental conditions such as weather), and jurisdiction-specific regulatory compliance data (e.g., compliance with GDPR, CCPA, or industry-specific regulations). In certain embodiments, contextual data may further include operational environment data (e.g., whether the system is operating on mobile, desktop, cloud, or on-premises infrastructure), environmental conditions (e.g., noise levels, lighting, temperature), and scenario-specific use case data for which the machine learning model is intended to be deployed. The blinded review cohort attribute data can also include evaluator identity data (e.g., name, affiliation, or contact information), demographic data (e.g., age, gender, ethnicity), evaluator background data (e.g., education, work experience, and certifications), system or model-related data (e.g., architecture, training data sources, and performance metrics), conflict of interest data (e.g., financial, personal, or organizational relationships), and technology proficiency data (e.g., level of familiarity with relevant machine learning systems). The multiple blinded cohort attribute data may further include evaluator population constraints (e.g., minimum and maximum number of evaluators), evaluator selection criteria (e.g., experience level thresholds, language proficiency requirements), evaluator diversity metrics (e.g., measures such as Simpson's Index or Shannon Entropy), evaluator assignment methodologies (e.g., random or stratified allocation), evaluator incentive data (e.g., compensation or recognition-based incentives), evaluator training protocols (e.g., onboarding and standardization procedures), evaluation round information (e.g., number of rounds and advancement criteria), and evaluation methodology (e.g., defined tasks, test cases, or use scenarios).

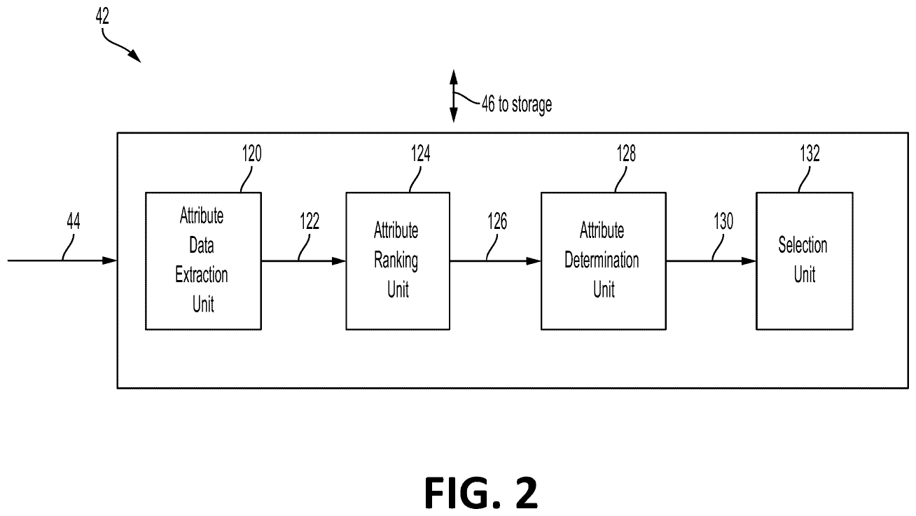

For example, as shown in FIGS. 1 and 2, the cohort selection unit 42 can include an attribute data extraction unit 120 for automatically extracting the attribute information from input data 44 that is associated with potentially relevant cohort attributes. The cohort attribute data associated with the input data 44 can include demographic information (e.g., age, gender, or location), behavioral information (e.g., usage patterns or purchase history), or other domain-specific information. The attribute data extraction unit 120 can be configured to apply one or more analytical techniques to the input data 44 to identify and extract relevant cohort attribute data needed for accurate cohort selection. The analytical techniques can include one or more statistical analysis techniques, a clustering technique, and other machine learning based techniques. The attribute data extraction unit 120 can then generate output attribute data 122 that includes a plurality of cohort attributes suitable for use in automated cohort selection.

The cohort selection unit 42 can also include an optional attribute ranking unit 124 for receiving the output attribute data 122 and for ranking the cohort attributes within the output attribute data 122. According to one embodiment, the attribute ranking unit 124 can perform a ranking process by applying one or more types of selection criteria, such as statistical significance, relevance to the model's performance, or regulatory requirements, to the cohort attribute data 122 so as to rank the cohort attributes for subsequent use during cohort selection. Once the attributes are ranked, the attribute ranking unit 124 generates attribute ranking data 126. The attribute ranking data 126 is subsequently received by the attribute determination unit 128, which selects or determines the subset of cohort attributes from the total set of cohort attributes that can be stored in the cohort storage unit 46. The attribute determination unit 128 then generates ranked cohort attribute data 130, which indicates the specific set of cohort attributes that will be used by the cohort determination unit 40 to identify and select the appropriate cohorts. Thus, the attribute ranking and determination process ensures that the most relevant and significant cohort attributes are considered during the cohort selection process, enhancing the accuracy and effectiveness of the model verification.

The cohort selection unit 42 can further optionally include a selection unit 132 for selecting the subset of cohorts from the total set of cohorts stored in the cohort storage unit 46 based on the cohort attribute data 130 generated by the attribute determination unit 128. Specifically, once the cohort attributes are identified and determined, the selection unit 132 can then automatically and dynamically determine or select the subset of cohorts based on the specific cohort attributes within the cohort attribute data 130. The selection unit 42 can employ a rule-based technique or a clustering technique to determine the subset of cohorts.

According to an alternate embodiment, the cohort selection unit 42 can select the subset of cohorts based on a predefined set of cohort attributes 46 selected by the enterprise rather than based on cohort attribute data. For example, the predefined cohort attributes 46 can be predefined by the enterprise and can include for example industry domain, cohort expertise, language of the cohort, experience of the cohort including years of experience, geographic location of the cohort, geographic regulations, context, geolocation, and the skills of the cohort. Those of ordinary skill in the art will readily recognize that the predefined cohort attributes can include a subset of these attributes, additional attributes, or a different set of attributes. Further, the cohort attribute data 130 can also include one or more of these predefined cohort attributes. The cohort selection unit 42 can then select a set of cohorts based on the predefined cohort attributes. The cohort selection can also further consider, in addition to the cohort attributes, selected types of machine learning model parameters or factors, including for example the type of machine learning model and the environment in which the machine learning model is intended to operate. The information can also include a portion of the information input into the cohort determination unit 40. The cohort determination unit 40 can then generate output cohort data 48, which can include one or more of cohort selection data, cohort attribute data, and a total set of cohort data. The output cohort data 48 can be stored in the distributed trust infrastructure 12. According to the present invention, each of the cohorts selected by the cohort selection unit 42 are unaware of the selection of the other cohorts in the subset (e.g., blinded), so as to form a blind selection process. The cohort determination unit 40 in essence selects verification participants (i.e., cohorts) specifically selected to verify a selected machine learning model based on a multi-factorial set of cohort attributes that can be predefined by the enterprise. The cohort blind selection process can serve to hide the identities and details of the cohorts from other cohorts in order to promote independent and unbiased reviews or evaluations of the machine learning models by the selected cohorts.

As used herein, the terms “blind” or “blinded” can refer to a process, state, or condition in which one or more cohorts or participants involved in the verification or evaluation of a machine learning model or associated system are intentionally restricted from accessing certain information about other cohorts, model origin, or evaluation context, or are otherwise unaware of the identity or existence of the other cohorts. In particular, a blind or blinded process may include preventing selected cohorts, reviewers, or evaluators from knowing the identities, roles, attributes, existence or evaluations of other cohorts involved in the same verification task. For example, in a blinded cohort selection process, the cohort selection unit 42 may select a plurality of cohorts to evaluate a machine learning model or system based on predefined cohort or system attributes (e.g., expertise, locale, primary language, regulatory familiarity), while ensuring that each selected cohort is unaware of the identity, presence, or selection of the other cohorts. This includes hiding or abstracting metadata, communication channels, contextual signals, or selection logic that can allow cohorts to coordinate, collude, or be influenced by other cohorts. The blinded process enhances the independence, objectivity, and reliability of verification results by preventing bias, undue influence, or cross-party contamination. The cohort determination and selection process may be further configured to incorporate relevant model parameters, deployment environments, or other contextual data to assign verification participants best suited for a given task, while preserving the blinded nature of the evaluation.

The model verification system 10 of the present invention can also include an objective assessment unit 50 for assessing or determining the consistency or agreement of the verification results between or among the different blinded cohorts who are selected to verify, and possibly to evaluate, the machine learning model or system. Once the cohorts are determined and selected by the cohort determination unit 40, then each of the selected cohorts can perform or apply a verification process on or to the selected machine learning model or generative artificial intelligence system. The results of the verification process are provided to the objective assessment unit 50 by way of cohort verification data 52. The cohort verification data can be stored in the storage unit 54. As used herein, the term “verifying” or “verification” of a machine learning model or a generative artificial intelligence system by one or more cohorts is intended to refer to the systematic process conducted by the cohorts to ensure that the model or system performance, reliability, accuracy, and compliance is consistent with or satisfies predefined standards and criteria. The verification process can include a series of checks and validations performed by the cohorts to establish the suitability of the model or system for deployment in its intended application. The verification can involve an evaluation of selected performance metrics or indicators, such as accuracy, precision, recall, F1-score, area under an ROC curve (AUC-ROC), and the like. The verification can also include one or more of, or any combination of, an assessment of the ability of the model or system to maintain performance under varying conditions and inputs, an assessment of the model or system to ensure that the model or system does not exhibit unfair biases against any particular group or demographic, ensure that the decisions of the model or system can be interpreted and understood by humans, and verify that the model or system adheres to relevant regulations, standards, and ethical guidelines. As used herein, the term “verification process” can refer to a structured and systematic procedure executed by the cohort to verify, validate, and confirm the performance and integrity of the machine learning model or the generative artificial intelligence system. The process can include multiple stages, each with specific tasks and objectives, aimed at thoroughly evaluating the model or system against established verification criteria. The verification process can include, for example, establishing goals, scope, and specific objectives of the verification process, identify the cohorts, and determine a verification plan. The verification plan can include methodologies, tools, datasets, and benchmarks to be used, gather representative datasets that reflect the real-world scenarios in which the model or system is to be deployed, run the machine learning model or generative artificial intelligence system on test datasets to establish baseline performance metrics, conduct a preliminary analysis of the outputs of the model or system and identify any immediate issues or concerns. The process can also include evaluating the model or system against comprehensive test cases to measure an accuracy, precision, recall, and other relevant metrics of the model or system including bias in the predictions generated thereby, ensure the model or system adheres to industry regulations and standards, and then refine and retrain the model or system to address any identified issues. The model or system can also be re-verified or re-evaluated by the cohorts to confirm improvements in the model.

The illustrated objective assessment unit 50 can include a statistical measurement unit 56 that is configured to apply one or more statistical measuring or assessment techniques to at least the cohort verification data 52, and optionally to the output cohort data 48, in order to measure or assess the consistency and reliability of the cohort-based verification of the machine learning model or the generative artificial intelligence system performed by the cohorts. Examples of suitable statistical measuring techniques that can be employed by the statistical measurement unit include an inter-rater reliability (IRR) analysis technique, a blind index technique, a Cohen's Kappa technique, a Intraclass Correlation Coefficient technique, a Fleiss' Kappa technique, a Krippendorff's Alpha technique, and the like. According to one embodiment, the statistical measurement unit 56 receives and processes the output cohort data 48 and the cohort verification data 52 and applies a selected statistical measuring technique to the cohort verification data 52 and optionally to the output cohort data 48, to determine an assessment score 58. For example, the statistical measurement unit 56 can employ an inter-rater reliability (IRR) technique to assess the level of agreement among cohorts (e.g., consistency of the reviews or verification) who verify or assess the performance or output of the machine learning model by the cohorts forming part of the cohort verification data 52. The IRR technique is a statistical measure used to determine the consistency or agreement between different cohorts or raters who verify, evaluate, assess or score the machine learning model or the generative artificial intelligence system. The IRR technique can be configured with selected parameters or settings corresponding to the methodological and procedural aspects of the verification task, such as the rating scale used, the nature of the items being evaluated, and the number of raters. The resultant assessment score 58 can be expressed or represented as a coefficient or numerical value that quantifies or is indicative of the level or degree of agreement among the cohorts (e.g., raters).

The statistical measurement unit 56 may apply different statistical techniques based on the nature of the data and the number of cohorts involved. The assessment score 58 can be calculated using additional and different types of statistical measurement techniques depending on the type of data and the number of cohorts. For example, Cohen's Kappa can be used to evaluate inter-rater agreement between two raters for categorical or qualitative items, correcting for agreement that could occur by chance. In contrast, Fleiss' Kappa or Krippendorff's Alpha may be employed when more than two raters are involved. The assessment score 58 generated by the statistical measurement unit 56 provides a quantitative measure of inter-rater agreement, which in turn serves as an indicator of the reliability and validity of the subjective evaluations provided by the cohorts. A high assessment score 58 indicates strong consistency and reliability in the ratings, suggesting that the cohorts are well-aligned in their evaluations. Conversely, a low score may suggest the need for enhanced training, revised evaluation criteria, or refinement of the verification protocol. The statistical measurement unit 56 can optionally apply a threshold value or cutoff score against which the assessment score 58 is compared, to determine whether the evaluations are sufficiently reliable. This threshold-based approach can function as a quality control mechanism, where assessment scores above the threshold indicate adequate agreement among the cohorts. Such techniques also reduce measurement error by identifying and mitigating random errors and individual biases, and they help ensure that the model verification process is reproducible by different cohorts under similar conditions.

According to another example, the statistical measurement unit 56 can employ a blind-index technique to verify the machine learning model or system. In one implementation, the blind-index technique involves the use of a separate, hidden dataset (e.g., a blind dataset) that is withheld from the model training and development process to provide an objective and unbiased evaluation of the model's performance. The blind dataset enables final validation of the model under conditions that simulate real-world deployment, thereby preventing overfitting and ensuring that the model's performance metrics reflect its ability to generalize to previously unseen data. In another implementation, the blind-index technique may refer to a method for secure and privacy-preserving analysis of cohort verification data. In such embodiments, the technique enables querying and statistical evaluation of the cohort-generated data without revealing sensitive or identifiable information. This privacy-preserving approach is particularly advantageous in settings where multiple independent cohorts contribute verification inputs and there is a need to maintain confidentiality during collaborative validation. The blind-index technique, whether used for data partitioning (e.g., test set isolation) or for privacy-preserving analysis, can generate one or more assessment scores 58. The assessment scores can be representative of model performance metrics, including but not limited to: accuracy, precision, recall (sensitivity), F1 score, and confusion matrix values. The assessment score 58 can be stored in the storage unit 54 and/or communicated to and stored in the distributed trust infrastructure 12 for further analysis or audit purposes.

The objective assessment unit 50 can also include a cohort setting unit 60 configured for storing and managing cohort settings data 60A. The cohort settings data 60A can be used by the statistical measurement techniques applied by the statistical measurement unit 56 to support validation and verification of the machine learning model and associated generative artificial intelligence system. The cohort settings data 60A can define the specific parameters, conditions, and criteria under which different cohorts perform the verification tasks as part of the verification process, thereby establishing a standardized, repeatable, and comprehensive assessment framework. This structured configuration enables consistent, objective, and reproducible evaluation of the model's performance across multiple cohort groups. In some embodiments, the cohort settings data 60A can include one or more verification metrics, cross-validation settings, holdout validation parameters, resampling methods, hyperparameter tuning configurations, and the like. The verification metrics can include, for example, accuracy, precision, recall, F1-score, area under the receiver operating characteristic curve (AUC-ROC), and similar performance indicators. In some implementations, a blinded cohort is responsible for verifying the machine learning model or associated AI system, operating under parameters defined by the cohort setting unit 60. The cohort setting unit 60 may provide the cohort settings data 60A, including verification metrics, to the statistical measurement unit 56. Based on these settings and the evaluations performed by the cohorts, the statistical measurement unit 56 can compute the assessment score 58. For example, the statistical measurement unit 56 can compute a blinding index score, which reflects the degree of independence between cohort attributes (e.g., demographics, professional background, affiliations) and the specific model or system under evaluation. A higher blinding index score indicates stronger cohort blinding, thereby reducing the potential for bias in the verification process. The statistical measurement unit 56 can also compute an inter-rater reliability score, such as Cohen's Kappa or the Intraclass Correlation Coefficient, to measure the level of agreement among cohort evaluations. A high inter-rater reliability score reflects consensus and objectivity in the cohort assessments.

In another embodiment, a cohort diversity score may be generated to quantify heterogeneity among cohort members based on selected attributes, including domain expertise, industry affiliation, language, cultural background, and demographic characteristics. Diversity metrics may include, for instance, Simpson's Index or Shannon's Entropy. Higher diversity scores indicate broader representativeness and help reduce bias from homogeneous perspectives.

The statistical measurement unit 56 can further compute a longitudinal performance score to track the consistency and stability of the model's performance across multiple evaluation rounds or over time. In addition, an evaluation round consistency score can be generated by comparing scores such as the blinding index, inter-rater reliability, and diversity metrics across distinct cohort panels or testing intervals. This score indicates the reproducibility and robustness of the verification process over successive evaluations. According to further embodiments, a cohort confidence score can be determined based on self-reported confidence levels provided by cohort members during the assessment process. When correlated with high inter-rater reliability, a high confidence score may serve as an additional indicator of the credibility of the evaluation results.

In some implementations, the statistical measurement unit 56 can determine a composite verification score by aggregating multiple component metrics, such as the blinding index, inter-rater reliability, diversity score, longitudinal performance trends, evaluation round consistency, and cohort confidence, into a single value representing the overall objectivity, consistency, and reliability of the verification process. The cohort setting unit 60 can further be configured to facilitate the setup, collection, analysis, and reporting of the assessment scores generated by the statistical measurement unit 56 and/or the blinded cohorts. In some embodiments, the cohort setting unit 60 can include an interface for defining cohort selection criteria and attributes, including but not limited to domain expertise, industry sector, language, cultural background, and demographic factors. This interface can support random or stratified assignment of cohorts to evaluation rounds or panels to ensure diversity, balance, and representativeness throughout the verification process.

The cohort setting unit 60 can also include or employ tools for creating verification tasks, scenarios, or test cases that the cohort employs to assess the AI system or model, which enables the development of rubrics or scoring guidelines for cohorts to rate different aspects of the AI system or model, such as performance, fairness, explainability, and robustness. The cohort setting unit 60 can also include data collection and management, which creates a secure and reliable mechanism for collecting cohort assessments, ratings, and confidence scores, while maintaining the blinding of identities and AI system or model details. The objective assessment unit thus helps store and manage the verification data, including longitudinal performance data and results from multiple verification or assessment rounds.

The objective assessment unit 50 can also include a set of trusted machine learning model principles 62 that can be optionally stored in the storage unit 54. When the statistical measurement unit 56 employs a statistical measurement technique to verify the machine learning model, adhering to trusted machine learning model principles ensures that the verification process is reliable, ethical, and robust. The trusted machine learning model principles are a set of guidelines and best practices designed to ensure that the models are developed and deployed in a manner that is fair, transparent, accountable, robust, secure, and respects user privacy and inclusivity. The principles can include, for example, a fairness and bias mitigation principle that employs a bias detection and correction technique to detect and mitigate biases in the data and machine learning model. The principle can include using fairness-aware algorithms and regularly auditing the model's predictions across different demographic groups. Further, the principles can ensure that the training and evaluation datasets are representative of diverse populations that the machine learning model serves. This can be accomplished by using stratified sampling and other techniques to maintain balance in the model. The principles can also employ fairness metrics, such as demographic parity, equal opportunity, and disparate impact, alongside traditional performance metrics.

The machine learning model principles can further include a transparency and explainability principle. The transparency and explainability principle can use interpretable models and apply explainability techniques, such as SHAP (SHapley Additive explanations) or LIME (Local Interpretable Model-agnostic Explanations) to provide insights into model decisions. The transparency and explainability principle can maintain thorough documentation of the model development process, including data sources, feature selection, and preprocessing steps, and the model's capabilities, limitations, and the context of its use to stakeholders can be clearly communicated.

The machine learning model principles can still further include an accountability and governance principle that can assign accountability for the model's performance and ethical use by establishing roles for data stewardship, model auditing, and compliance oversight. The accountability and governance principle can adhere to established ethical guidelines and industry standards for model development and deployment and can implement governance frameworks to ensure ongoing compliance. The accountability and governance principle can maintain detailed audit trails for all stages of model development, from data collection to deployment, ensuring traceability and accountability.

The machine learning model principles can also include reliability and robustness principles. The reliability and robustness principle allows the user or system to perform extensive testing under varied conditions to ensure that the model is reliable and performs well across different scenarios. This includes stress testing and adversarial testing. The reliability and robustness principle provides for conducting thorough error analysis to understand and address the model's failure modes. This helps in improving the model's robustness and reliability and can implement continuous monitoring mechanisms to track model performance over time and detect any degradation or unexpected behavior.

The machine learning model principles can still further include an inclusivity and accessibility principle. The inclusivity and accessibility principle requires that the model be configured to be inclusive and accessible to all users, considering the needs of various demographic groups, including those with disabilities. The inclusivity and accessibility principle also requires engagement with diverse stakeholders, including those who might be affected by the machine learning model, to gather input and feedback throughout the model development and deployment process.

The statistical measurement unit 56 can thus process the output cohort data 48, the cohort verification data 52, the machine learning model principles data 62A and the cohort setting data 60A when generating the assessment score 58. The assessment score can be stored in the distributed trust infrastructure 12 and optionally in the storage unit 54. Similarly, the set of trusted principles 62 can correspond principles associated with generative artificial intelligence system.

With reference again to FIG. 1, the illustrated system or model verification system 10 further includes a system or model evaluation unit 70 for evaluating either the machine learning model or the generative artificial intelligence system based on a set of enterprise specific factors or parameters. As described herein, evaluating a machine learning model or a generative artificial intelligence system refers to assessing the performance of the model or system for the intended application or purpose. Although the evaluation unit 70 can be used to evaluate the machine learning model or the generative artificial intelligence system, the evaluation unit is described as evaluating a machine learning model the sake of case and simplicity. The evaluation can involve analyzing the ability of the machine learning model to generate accurate predictions on new unseen data, and ensuring the machine learning model meets the necessary, required, or acceptable performance criteria and standards. The model evaluation also helps determine the model's performance, identify potential issues with the model, and guide improvements that can be made to the model. As used herein, the term “performance” refers to one or more measurable characteristics or behaviors of a machine learning model or generative artificial intelligence system that relate to its accuracy, reliability, robustness, and overall suitability for a defined task, operational context, or intended use case. Performance can be evaluated based on enterprise-specific evaluation parameters, regulatory requirements, application-specific criteria, or other relevant standards. Evaluating performance includes assessing the ability of the machine learning model or generative AI system to generate accurate outputs or predictions on new, previously unseen data. Performance evaluation may further involve determining whether the model satisfies minimum threshold levels, acceptable error margins, or required precision or recall metrics, among others. Additional factors considered in performance evaluation may include latency, throughput, robustness under varied conditions, consistency across deployments, and adherence to domain-specific or jurisdiction-specific standards. The evaluation of performance, as carried out by the evaluation determination unit 78, may also identify model limitations, deficiencies, or unintended behaviors that affect the trustworthiness or usability of the model. Such evaluations may guide iterative improvement or retraining processes to improve overall system reliability. In certain embodiments, performance can also reflect the alignment of the model with one or more contextual or environmental factors relevant to the deployment environment, including but not limited to language, geographic region, user population characteristics, or legal or regulatory constraints. Accordingly, performance evaluation within the present invention enables objective and reproducible assessments of whether a machine learning model or generative AI system is functionally appropriate, operationally reliable, and suitable for its intended purpose.

According to one embodiment, the evaluation process employed by the evaluation determination unit 78 can include selecting and defining evaluation criteria of the model, including performance metrics of the model (e.g., accuracy, precision, recall, F1-score, ROC-AUC, mean squared error (MSE), and R-squared, and the like), robustness (e.g., assessing the model's stability under varying conditions and data distributions), bias and fairness, interpretability (e.g., evaluate the model's transparency and ability to explain model generated predictions), and compliance. The evaluation process can also involve preparing the model data by dividing the dataset into selected types of datasets, including a training dataset, a validation dataset, and a test dataset, and then cleaning and preprocessing the data. The machine learning model can then be trained on the training datasets using suitable hyperparameters, and the hyperparameters can be tuned using selected tuning techniques, such as grid search, random search, or Bayesian optimization. The model can then be validated by using the validation datasets to fine-tune the hyperparameters and prevent overfitting. The model can then be tested with the test or evaluation datasets to assess or evaluate the performance of the model.

The illustrated model evaluation unit 70 can include an evaluation determination unit 78 for receiving and processing various model evaluation data and then generating evaluation data 82 that is indicative of the performance of the machine learning model. The performance evaluation involves assessing the model's predictions against actual outcomes using specific criteria. The model evaluation data can include, for example, test harness data, benchmarking data, evaluation ground truth data, threshold setting data, and the like. According to one embodiment, the model evaluation unit 70 can include a storage unit 74 for storing scenario-based test harness data. The scenario-based test harness data is data representative of a framework or environment that is configured to simulate real-world situations and conditions under which the machine learning model is deployed. The scenario-based test harness data when processed by the evaluation determination unit 78 provides for comprehensive testing of the machine learning model by evaluating the model's performance across a variety of scenarios that it may encounter during use. The scenario-based test harness data can include data that simulates different real-world conditions, including varying data distributions, noise levels, and edge cases. The scenario-based test harness data also allows for controlled and repeatable model testing environments where specific model variables and parameters can be adjusted systematically. The evaluation determination unit 78 can process the test harness data so as to be able to test the model with a wide range of data to cover different situations that the model may encounter during use. During testing and evaluation of the model with the scenario-based test harness data, the evaluation determination unit 78 can collect and analyze various performance metrics to evaluate the model's robustness, accuracy, precision, recall, and other relevant factors. Depending on the scenario, additional performance metrics relevant to the specific context can be collected, calculated, or determined by the evaluation determination unit 78, including response time, robustness to noise, and the like. The scenario-based test harness data can also optionally include automation tools data that enables the evaluation determination unit 78 to run tests systematically and efficiently on the machine learning model to ensure consistency and repeatability of the model. The scenario-based test harness data when processed by the evaluation determination unit 78 can provide an accurate assessment of the performance of the machine learning model in real-world applications when compared to traditional testing with static datasets. The scenario-based test harness data also enables the evaluation determination unit 78 to identify potential weaknesses and failure points of the machine learning model by exposing the model to a wide range of conditions.

The illustrated model evaluation unit 70 can also include a storage unit 72 for storing evaluation ground truth data. The evaluation ground truth data refers to the set of data used as a baseline or standard that can be processed by the evaluation determination unit 78 to assess or evaluate the performance of the machine learning model. The evaluation ground truth data can include accurate, verified, and labeled data that is considered correct and accurate and represents the correct outcomes of the machine learning model, and thus is capable of serving as reference or test data against which predictions or outputs generated by the model can be compared. When processed by the evaluation determination unit 78, the evaluation ground truth data can serve as a reliable reference to measure and evaluate the accuracy and effectiveness of the model, ensure that the model's predictions align with real-world outcomes or expert annotations, and allows for the evaluation determination unit 78 to calculate or determine selected performance metrics, such as accuracy, precision, recall, F1 score, and AUC-ROC by comparing model predictions with the evaluation ground truth data.

According to one embodiment, the evaluation determination unit 78 can compare the predictions generated by the machine learning model under evaluation with the ground truth data to identify correct and incorrect model predictions (e.g., model output). The comparison performed by the evaluation determination unit 78 helps determine if errors exist and the evaluation determination unit 78 can analyze the errors and determine where the model is making incorrect predictions. The evaluation ground truth data is highly accurate labeled data that is relatively free from errors as it serves as the standard for evaluation. The data also represents the full range of scenarios the model is likely to encounter in real-world applications. Further, the labeling or annotations in the ground truth data are consistent and standardized to ensure fair comparison.

The model evaluation unit 70 can further include a storage unit 76 configured to store benchmark data. The benchmark data refers to one or more standards, reference datasets, or performance criteria against which the machine learning model is evaluated. The benchmark data, when processed by the evaluation determination unit 78, can be used to assess the effectiveness of the model and compare the model's performance against other models or predefined performance thresholds. The benchmark data can include, but is not limited to, performance metric data, baseline model data, ground truth data, computational efficiency data, generalization and robustness data, fairness and bias metric data, explainability data, and user engagement data. The performance metric data may include quantitative indicators such as accuracy, precision, recall (or sensitivity), F1 score, area under the curve (AUC), mean squared error (MSE), root mean squared error (RMSE), and mean absolute error (MAE). Accuracy refers to the ratio of correctly predicted instances to total instances. Precision refers to the ratio of true positives to the sum of true and false positives. Recall, or sensitivity, refers to the ratio of true positives to the sum of true positives and false negatives. The F1 score represents the harmonic mean of precision and recall. AUC refers to the area under the receiver operating characteristic (ROC) curve, which indicates the trade-off between true positive rate and false positive rate. MSE measures the average squared difference between predicted and actual values, while RMSE is the square root of the MSE and provides the error in the same units as the target variable. MAE measures the average absolute difference between predicted and actual values.

The baseline model data includes performance data from one or more baseline models used for comparative evaluation and may be curated and validated to ensure correctness and consistency. Ground truth data refers to accurately labeled reference data used to evaluate model predictions and may be similar to or derived from evaluation ground truth data stored in storage unit 72. Computational efficiency benchmark data relates to the model's performance in terms of time and resource usage, including inference time (e.g., time required to make a prediction), training time (e.g., total time to train the model), memory usage (e.g., RAM or GPU memory consumed), and scalability (e.g., model performance as data or resource demands increase). Generalization and robustness data evaluate the model's ability to perform reliably on unseen data or under varying conditions. Such data can include cross-validation scores from training-validation splits and test datasets representative of different distributions, domains, or timeframes. Fairness and bias benchmark data include metrics that evaluate potential disparities in model predictions across demographic groups. These metrics may include demographic parity (equal prediction rates across groups), equalized odds (equal true and false positive rates across groups), and disparate impact ratio (ratio of favorable outcomes between groups). Explainability and interpretability benchmark data pertain to the model's transparency and the extent to which model predictions can be understood and justified. This data may be generated using interpretable models, attribution methods, or user-centric explainability techniques. Engagement metric data applies to models deployed in user-facing applications and may include user satisfaction scores and usage metrics, such as session duration, frequency of use, and user retention rates. In some embodiments, the evaluation determination unit 78 can compute an overall model evaluation score or multiple sub-scores based on the benchmark data. These scores assist in determining model readiness, identifying areas for improvement, and supporting decision-making in model selection and deployment.

The model evaluation unit 70 can further include threshold settings 79. The threshold settings 79 may include threshold data that can be received and processed by the evaluation determination unit 78 to assess the performance and behavior of the machine learning model. The threshold data can define one or more decision thresholds used to interpret the model's outputs and can influence classification, scoring, or other evaluation results. In some embodiments, the threshold data may include various types of thresholds, such as fixed thresholds, which apply a constant value across all predictions; dynamic thresholds, which adjust automatically based on factors such as data distribution, input type, or contextual variables; and cost-sensitive thresholds, which are set by taking into account the relative cost of false positives versus false negatives. The threshold data may also include class-balanced thresholds designed to compensate for imbalanced class distributions in the training or evaluation data. Additional threshold types can include metric-optimized thresholds, which are selected to maximize or improve specific evaluation metrics such as F1 score, precision, recall, or AUC-ROC; percentile-based thresholds, which are set according to a specified percentile of the predicted probability scores; and multi-threshold settings, which may be used in ensemble model configurations where individual models operate with separate thresholds and their outputs are aggregated. The threshold data may further include application-specific thresholds, which are customized for the unique operational or business requirements of a given application context. These various threshold types enable flexible and context-aware performance evaluation of the machine learning model under a variety of real-world conditions.

The evaluation determination unit 78 can include a parameter application unit 80 for applying one or more enterprise parameters, and one or more of (or two or more of) the evaluation ground truth data, scenario-based test harness data, benchmark data, and threshold setting data, to the model verification results (e.g., assessment score 58) generated by the objective assessment unit 50 so as to evaluate the performance of the machine learning model.

The set of measurable attributes can be compared or processed with the enterprise parameters. The parameter application unit 80 can include any selected parameters associated with or defined by the enterprise. The enterprise parameters can include, by simple way of example, fairness, one or more of, or any combination of, reliability, transparency, security, accountability, safety, privacy, explainability, integrity, and sustainability. Additional or different parameters can include one or more of security firewall and attack prevention parameters, malicious detection parameters, code leakage parameters, prompt injection protection parameters, adversarial protection parameters, malware analysis parameters, vulnerability assessment parameters, backdoor detection parameters, model integrity parameters, harmful content related parameters, fail safe mechanism parameters, sensitive data protection parameters, intellectual property related parameters, personal data collection related parameters, data completeness related parameters, data quality parameters, data bias parameters, data provenance parameters, solution bias related parameters, machine learning model logic related parameters, model accuracy related parameters, drift and stability related parameters, energy efficiency parameters, and the like. The parameter application unit 80 can further process the assessment score 58 in light of one or more of the enterprise parameters. The evaluation determination unit 78 can then generate output model evaluation data 82 indicative of an evaluation of the performance of the machine learning model. The output model evaluation data 82 can be stored in the distributed trust infrastructure 12.

The model verification system 10 can further include a result assessment unit 90 for further assessing the evaluation results in the form of the output model evaluation data 82 generated by the model evaluation unit 70. The result assessment unit 90 can automatically review or assess the performance and reliability of the output model evaluation data 82 or can include or employ a cohort or other type of reviewer to review the output model evaluation data 82, so as to further assess and review the performance and reliability of the machine learning model or associated generative AI system. According to one embodiment, the result assessment unit 90 can include an independent evaluation unit 92 that independently evaluates and assesses the performance and reliability of the machine learning model or system using a separate, unbiased set of data (e.g., dataset) or through external review by the reviewer to ensure objective and reliable model results. As used herein, the term “reliable” or “reliability” in this context encompasses accuracy, consistency, generalizability, robustness, fairness, reproducibility, and validity, thus ensuring that the results of the machine learning model or system are trustworthy and dependable when applied to new, unbiased data. Specifically, in terms of consistency, the machine learning model or system generates similar results across different data runs or data samples in order to demonstrate stability and repeatability in the performance of the model. In terms of accuracy, the predictions generated by the model or system closely match the true outcomes or labels in the dataset, indicating high precision and correctness. In terms of generalizability, the model performs well not only on the training data but also on new, unseen data (the separate unbiased dataset), showing that the model can generalize beyond the specific instances the model was trained on. In terms of robustness, the model or system can maintain performance across different subsets of data and under various conditions, suggesting model resilience to variations and potential data noise. In terms of fairness, the model or system does not exhibit significant bias or unfair treatment across different groups or categories within the dataset, ensuring equitable performance. In terms of reproducibility, the process and methodology used to train and evaluate the model or system can be replicated by others, leading to similar results, which supports the credibility of the findings. In terms of validity, the predictions generated by the machine learning model or associated system are meaningful and relevant in the real-world context for which the model was developed. Moreover, the independent evaluation performed by the reviewer provides an unbiased evaluation of the model or system performance free from any influence of the data used during the model training and development phases and ensures that the machine learning model or system generalizes well to new, unseen data. The independent evaluation also helps identify and mitigate any biases or overfitting that may have occurred during the model training process, thus ensuring that the machine learning model performs well across diverse datasets.

The result assessment unit 90 can also optionally include a scenario evaluation unit 94 for assessing the performance of the model or system under various predefined conditions or scenarios that simulate real-world or real time conditions or situations. The evaluations help ensure the model or system exhibits robustness, reliability, and effectiveness across different contexts the model may encounter in actual deployment.

The result assessment unit 90 further optionally includes a peer evaluation unit 96 for assessing the model or system outputs by independent experts or peers with relevant or selected expertise. The peer evaluation provides an objective and comprehensive review of the machine learning model and model results or the generative AI system. The peer evaluations serve to generate unbiased feedback or assessments from peers who are not involved in the development of the model or system, while ensuring that the model or system meets high standards of quality, rigor, and scientific validity. The peer evaluations help identify potential errors or biases that the original model or system developers may have overlooked.

The result assessment unit 90 can also include a peer comparison unit 98 for assessing the performance of the model or system by comparing the model or system to other machine learning models or systems or benchmarks. The peer evaluation unit 96 can provide an interface and allow for analyzing the evaluation results from all of the model evaluations or findings. The peer evaluation unit 96 can highlight discrepancies, areas of agreement or disagreement. The peer evaluation unit 96 can maintain anonymity or blinding of cohort identities during the peer evaluation process to ensure objectivity. The peer comparison unit 98 can compare and analyze the peer evaluations and assessments submitted by different evaluators or cohorts. The peer comparison unit 98 employs one or more statistical techniques, such as calculating inter-rater agreement metrics, clustering algorithms, and longitudinal trend analysis, to identify areas of convergence, divergence, and potential biases among the assessments of the cohorts, enabling the identification of significant discrepancies that may require further investigation or arbitration. The peer comparison unit 98 can also generate visualizations or reports that highlight the degree of alignment or disagreement among evaluators for different aspects of the AI system or model evaluation. The peer comparison unit 98 can also employ or apply an inter-rater arbitration technique for resolving disagreements or conflicts among evaluators or cohorts when significant discrepancies are identified and adjudicate the conflicting evaluations. The peer comparison unit 98 allows the system to maintain audit trails and documentation of the arbitration process and outcomes for accountability and traceability. The peer comparison helps determine the relative strengths and weaknesses of the machine learning model or system and provides context for the model performance. The per comparison measures the model's performance against established benchmarks or peer or other models, and the peer comparison provides context to the model's performance, thus making it easier to understand the strengths and weaknesses of the model.

The result assessment unit 90 can further optionally include an inter-rater arbitration unit 100 for evaluating the machine learning model or system to resolve discrepancies or inconsistencies in the ratings or evaluation of the machine learning model o system by different cohorts or evaluators. When multiple cohorts are involved in labeling data or assessing model performance, the cohorts may not always agree on the model or system outcomes. The inter-rater arbitration addresses any potential disagreements to achieve a more reliable and accurate model evaluation. The inter-rater arbitration ensures that the evaluation criteria are applied uniformly across different cohorts, thus leading to consistent model or system results and enhancing the quality and reliability of the labeled data (e.g., training data and validation data). The result assessment unit 90 can generate assessment results 102 that are stored in the distributed trust infrastructure 12.

The model verification system 10 can include a system or model trust card generation unit 110 for generating a model trust card 112 or a system trust card from selected data that is stored in the distributed trust infrastructure 12. As used herein, the “model trust card” can refer to a document or digital artifact that provides detailed information about characteristics, performance, reliability, and/or trustworthiness information or metrics of one or more machine learning models. The model trust card can be configured or designed to enhance transparency and to facilitate trust by offering stakeholders a comprehensive overview of the machine learning model, including the intended use, limitations, performance metrics, ethical considerations, and any potential biases of the machine learning model. The model trust card can display or include any selected combination of model specific information of the verified and evaluated models, including for example the model name and version, model developer information, model purpose, scope and limitations of the model, training data information including a description of the data used to train the model (e.g., data sources, collection methods, and preprocessing steps), verification and evaluation information, validation and test information including details about the datasets used for validation and testing, and performance metrics information including accuracy, precision, recall, and F1 Score. The model trust card can also display bias mitigation information, fairness metric information directed to results of any fairness assessments, model interpretability information, feature importance information, audit and monitoring information, data privacy information, and security protocol information. The model trust card 112 provides a clear and detailed understanding of the machine learning model, making it easier for stakeholders in an enterprise to review the model specific information set forth therein, and to make selection decisions based on the results of the verification and evaluation processes, and associated assessments. The model trust card as such enables the enterprise to make informed decisions about which models to adopt based on the information set forth in the model trust card.

As used herein, the “system trust card” can refer to a document or digital artifact that provides detailed information about characteristics, performance, or trustworthiness information or metrics of a generative AI system that can employ one or more machine learning models. The trust card can be configured or designed to enhance transparency and to facilitate trust by offering stakeholders a comprehensive overview of the system, including the intended use, limitations, performance metrics, ethical considerations, and any potential biases of the machine learning model. The system trust card can display or include any selected combination of system specific information, including for example the machine learning model name and version, system and model developer information, system and model purpose, scope and limitations of the system and model, training data information including a description of the data used to train the model (e.g., data sources, collection methods, and preprocessing steps), validation and test information including details about the datasets used for validation and testing, and performance metrics information including accuracy, precision, recall, and F1 Score. The system trust card can also display bias mitigation information, fairness metric information directed to results of any fairness assessments, model interpretability information, feature importance information, audit and monitoring information, data privacy information, and security protocol information. The system trust card can provide a clear and detailed understanding of the system, making it casier for stakeholders or reviewers to trust and adopt the system. Further, the system trust card provides a clear and detailed understanding of the generative AI system, making it easier for stakeholders in an enterprise to review the system specific information set forth therein, and to make selection decisions based on the results of the verification and evaluation processes, and associated assessments. The system trust card as such enables the enterprise to make informed decisions about which systems to adopt based on the information set forth in the system trust card.

The system or model trust card generation unit 110 can also include a storage unit 114 that can store the model trust cards 112 or the system trust card. The storage unit 114 can be a specialized repository used to store the model and systems trust cards and to track and manage machine learning models and generative AI systems over time, capturing various aspects of model or system development, deployment, performance, and updates. The purpose of the storage unit 114 is to maintain a record of various versions of the machine learning models and systems, also store including updates, changes, and improvements over time. The storage unit 114 can also store data associated with the monitoring and logging of model performance metrics in different environments and across various time periods. The storage unit 114 can also store decisions, changes, and performance outcomes of the machine learning model. The storage unit 114 can also store and provide the necessary data for generating the model trust card 112, which summarizes the trustworthiness, reliability, and performance of the machine learning model.

The present invention is thus directed to a system and method for continuous blinded verification of machine learning models under real-world conditions that changes temporally and geographically. The model verification system 10 of the present invention initially employs a model aggregation unit 20 to collate and aggregate together the machine learning models associated with an enterprise. The models can have associated therewith metadata. The aggregated machine learning models can be stored in the distributed trust infrastructure 12, which can include a blockchain.

The model verification system 10 can then employ a cohort determination unit 40 for determining a plurality of cohorts that can be used to verify the machine learning model based on multi-factorial cohort attributes, including for example industry domain, skills, locale, expertise, primary language, years of experience, and the like. The cohort determination unit 40 also considers the context, geolocation, circumstances, geo-specific regulations, and the environment in which the machine learning model will run. The cohorts that are selected to verify the machine learning model can be passed along to an objective assessment unit 50 so that the cohorts can verify the machine learning model. The cohorts can also be stored in the distributed trust infrastructure 12.

The model verification system 10 of the present invention can also include an objective assessment unit 50 for having the plurality of cohorts perform a verification process on the machine learning model. The verification process performed by the cohorts can utilize and process the machine learning model, cohort settings, and cohort verification data 52. The cohorts are unaware of each other so as to form a blind verification process that promotes independent and unbiased individual evaluations of the machine learning model. The multiple blinded cohorts improve the verification process of the machine learning model by preventing bias and influence from any one source when verifying the model. Further, the cohort determination unit 50 can employ a statistical measurement unit 56 that can apply one or more statistical measurement techniques, such as blinding index and inter-rater reliability, to generate an assessment score that helps determine if the verification process performed by each of the cohorts is objective and consistent. The performance of the machine learning model is also tracked through electronic model trust cards that capture or display selected and customizable model information. According to one embodiment, the machine learning model can be verified multiple times by the same set of cohorts or by a different set of cohorts. Further, the blinded verification process can track and report a blinding index statistic to quantitatively measure the degree to which the cohorts and model details are effectively blinded from each other. A high blinding index score indicates independence between the cohorts and model. The verification process can also generate or analyze confidence scores from the cohorts on different verification aspects. The consistency in the confidence levels or scores, as measured by inter-rater agreement, lend credibility to model results. The assessment score generated by the objective assessment unit 50 can be stored in the distributed trust infrastructure 12 and can also be conveyed to a model valuation unit 70.

The model evaluation unit 70 of the present invention can then evaluate the machine learning model based on selected data and based on selected enterprise parameters. The evaluation can be performed by cohorts or automatically by the same cohorts that performed by the verification process, or by a different set of cohorts. The model evaluation unit 70 can thus employ the assessment scores and selected additional data, such as ground truth data, benchmark data, test harness data, and threshold setting data to evaluate the model performance and effectiveness. The model evaluation unit 70 can employ a parameter application unit 80 to process the data based on selected enterprise specific parameters, such as for example Fairness, Transparency, Explainability, Accountability, Data Integrity, Reliability, Security, Safety, Privacy, and Sustainability. The cohorts can also independently evaluate the machine learning model based on the enterprise parameters. The model evaluation unit 70 can then generate output model evaluation data 82 that can be stored in the distributed trust infrastructure 12 and can be conveyed to a result assessment unit 90.

In this regard, the result assessment unit 90 can include a statistical measurement unit 100, such as an inter-rater arbitration unit, that can receive and process the output model evaluation data 82 that includes data from the cohorts acting as evaluators to determine or calculate assessment results 102. The assessment results 102 can include an evaluation score, such as an inter-rater reliability statistic score, like a Cohen's Kappa score. A high evaluation score suggests consistent evaluations by the cohorts. The result assessment unit 90 assesses the effectiveness and reliability of the evaluation process, ensuring that the assessments and findings provided by the cohorts are objective, consistent, and trustworthy. The result assessment unit 90 can be configured to validate the objectivity and independence of the evaluations by analyzing the degree of agreement or disagreement among the evaluators or cohorts through, for example, inter-rater reliability metrics and peer comparisons. The result assessment unit 90 can also measure and identify potential biases, inconsistencies, or outliers in the evaluations by comparing evaluator or cohort assessments across different subgroups, attributes, or evaluation rounds. The result assessment unit 90 can help resolve conflicts or significant discrepancies among cohorts through, for example, the inter-rater arbitration component, ensuring that the final assessment is reconciled and reflects a consensus or adjudicated outcome.

The machine learning model can be further tested and evaluated under different operating scenarios, contexts, geographic locations, temporal conditions (e.g. time of day/week), regulatory environments, and the like to evaluate the robustness and adaptability over time of the model. Further, the machine learning model can be verified and/or evaluated in multiple rounds by different cohorts selected based on their attributes. The system can compare blinding index and inter-rater reliability scores across the different rounds to validate independence and reproducibility of model results.

According to another embodiment, disagreements between cohort verifications and evaluations can be stored in the distributed trust infrastructure 12. The disagreements can be resolved through facilitated discussion while maintaining blindness. Subsequent consensus ratings can then be determined. The model verification system 10 can also include a model trust card generation unit 110 for generating a model trust card 112. The model trust card 112 can have any selected configuration and can display any of the data or information stored in the distributed trust infrastructure 12 and generated by the portions of the model verification system 10. The model trust card 112 can be predefined or preconfigured to display selected types of information or can be customized to display user preferred data. The model trust card 112 can be stored in the distributed trust infrastructure 12. According to one embodiment, the model trust card can be stored as a non-fungible token (NFT) on the blockchain.

As generative AI systems and machine learning models are increasingly deployed, it is desirous to document details about the systems performance and history over time. According to one embodiment, the system or model trust card generation unit 110 can create, maintain, and update model trust cards 112 and system trust cards that include information documenting or recording details of generative AI systems and models, including how the system or model operates over time. The model trust card 112 can be a comprehensive collection of the specific machine learning models that are gathered over a period of time, such as over an extended period of time. The system trust card can also be a comprehensive collection of the specific generative AI system that is gathered over a period of time. The model trust card 112 can include all aspects of the machine learning model or of a system employing the model. The model trust card 112 can be a longitudinal model trust card 112 since the card can be used to document the continuity and temporal aspects of the model. As such, the model information can be collected, maintained, and analyzed over a long period of time, rather than being a snapshot of a single moment. The continuous accumulation of model or system information allows the user to track changes and trends in the performance of the model or system, providing a completer and more accurate picture of the overall model.

The model trust card generation unit 110 can create the model trust card 112 that longitudinal tracks and dynamically evaluates generative AI systems and machine learning models, including their adaptations to different contexts. The model trust card 112 can store information and evaluation metrics of the models over time, based on dynamic, multi-party blinded evaluations across selected enterprise parameters, such as, for example, the fairness, transparency, explainability, accountability, data integrity, reliability, security, safety, privacy, and sustainability parameters. The model trust card 112 can be dynamically updated as the models evolve, adapt, and migrate over time. The information in the model trust card 112 can include model performance, model changes, evaluations of the model, and adaptations and trustworthiness. The model trust card 112 can also store or set forth information on the context-specific adaptations and adjustments in the model, in both real-time and temporal situations, to provide a comprehensive understanding of the model's performance in diverse application scenarios. The model trust card 112 thus captures and stores the results of continuous multi-stakeholder blinded verification of AI systems and machine learning models across selected enterprise parameters and performed under different operating conditions over time. The model information can be displayed in any selected format. The same applies to the creation of the system trust card.

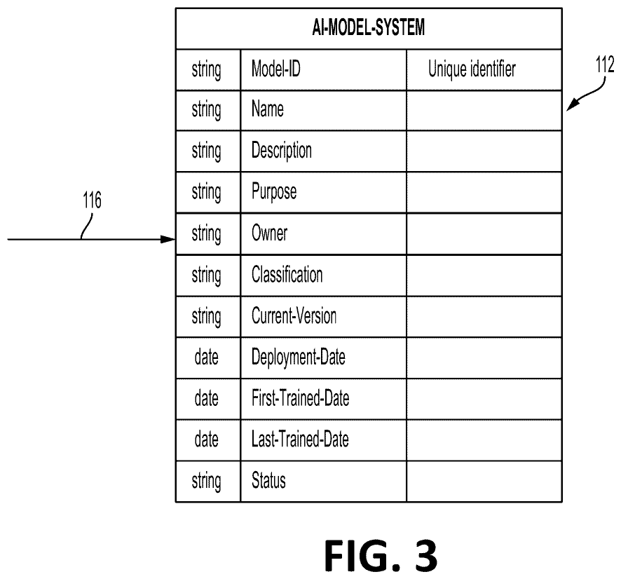

FIG. 3 is an example of a suitable model trust card 112. The model trust card 112 can include information associated with a selected machine learning model, such as name, description, purpose, owner, classification, current version, deployment date, first trained date, last trained date, status, and the like. The model trust card 112 can have a unique identifier associated with each piece of information. The model trust card 112 can receive selected types of information 116 that help form the details of the model trust card 112. The model information 116 that is employed to form the model trust card 112 can include model or model related information from a number of different sources, from model performance data, training data including training-run data, security data, model history data, model snapshot data, model requirements data, policy data, model deployment data, model evaluation data including evaluation results and evaluation criteria, subject matter expert data, AI system card data, stakeholder information, deployment information, subject matter expert information, security data, model historical information, and the like. The same applies to the system trust card. The model and system trust cards can have any selected format or structure. According to one embodiment, the trust card can have a tabular format.

The verification and evaluation of the machine learning models and the generative AI systems enables the system to employ and deploy models and systems that are effective for the intended purposes of the enterprise. This avoids deploying models in systems that are ineffective and hence unreliable. By avoiding the use and deployment of ineffective and unreliable models, the model verification system 10 can efficiently employ processing and computing resources, and hence improve the overall function and operation of the system.

In modern computing environments, the deployment of machine learning models an generative AI systems often involves substantial computational overhead, particularly when multiple candidate models must be verified, evaluated, selected, and/or operationalized. The present system 10 addresses these challenges by providing a technical solution that automatically and efficiently selects and deploys reliable and high-performing models in a way that improves the operation and functioning of the underlying computing infrastructure. Rather than manually evaluating model performance or relying on arbitrary deployment heuristics, the system 10 implements a structured and scalable approach to model and system selection based on dynamic evaluation of model performance, contextual operating parameters, and resource constraints.

At the core of the system is a model evaluation and selection engine and associated units that apply a set of machine-implemented techniques to determine the suitability of each model within a candidate pool of models. The verification and evaluation techniques include not only accuracy-based metrics but also computational cost assessments, latency considerations, and robustness to variable data conditions. By applying these selection criteria in real time or near-real time, the system 10 ensures that only models that are suitable for their intended purpose also meet predefined performance thresholds and resource profiles, and hence are selected for deployment. This enables the computing system to dynamically optimize model usage in accordance with available hardware capabilities and system objectives.

Importantly, the present system 10 provides improvements to the functioning of a computer itself, in contrast to merely automating a mental process or applying abstract mathematical models. For example, by selectively deploying only high-performing models, the system reduces unnecessary processor cycles, memory consumption, and power usage associated with maintaining or invoking suboptimal models. The system 10 may also deactivate or offload less efficient models, thereby freeing system resources for other computational tasks. These are not generic improvements, but rather specific enhancements to the operation and efficiency of computing hardware in machine learning deployment contexts. Furthermore, the claimed invention integrates with existing machine learning pipelines and modifies their behavior in a concrete and useful way. Rather than indiscriminately applying every available model to incoming data, the system verifies and evaluates models that are optimally suited for the intended purpose.

The technical features of the invention go beyond mere data manipulation or information display. The system executes specific technical steps involving data structuring, metric computation, and decision logic that are not routine or conventional in the field. For example, the system may track model behavior across distributed environments, compute time-series based drift metrics, or apply cost-sensitive tradeoffs during model arbitration. These steps are implemented via computer-executable components that materially improve the technical process of model deployment.

### AI Agent Evaluation

According to another embodiment of the present invention, the system can be configured to employ artificial intelligence (AI) agents and to assess and score the operational and trustworthiness aspects, and optionally additionally the performance aspects, of the AI agents.

As used herein, the term “enterprise computing environment”, whether in singular or in plural form, refers to a computing infrastructure that supports digital operations, data flows, and information systems of an enterprise. Such environments can include, for example, electronic devices, distributed computing platforms, cloud-based systems, on-premises servers, edge devices, computing devices, data storage systems, communication networks, associated software applications and components, and the like, which can be configured to interact with internal and external data sources and to support enterprise-level applications, processes, and services.

In various embodiments, the AI agents can be implemented as a computational entity configured to autonomously or semi-autonomously receive, perceive, and process information from one or more data sources in one or more data environments, make determinations based on such information, and perform one or more responsive actions to fulfill defined objectives. The AI agent can interface with one or more underlying machine learning models, which serve as analytical or inferential engines within the broader AI framework of the enterprise computing environment. In one embodiment, the AI agent can provide supervisory control over the machine learning models, manage operational logic, control data flow and decision-making hierarchies, and control communications with external systems or components. In contrast, the machine learning models are typically responsible for lower-level tasks, such as data-driven inference, prediction, or classification based on statistical patterns learned from training data.

The interaction between the AI agent and the machine learning model can proceed through a structured process. In some implementations, in addition to interfacing with the machine learning models, the AI agent can collect input data from various data sources, including but not limited to sensors, application programming interfaces (APIs), databases, user interfaces, and the like. The AI agent can perform preprocessing operations on the input data, such as data cleaning, normalization, transformation, or feature extraction, and may generate one or more formatted data inputs suitable for use by the machine learning model. The AI agent may then invoke the machine learning model by submitting the formatted data input for analysis. The machine learning model, in response, can return an output, such as a prediction, confidence score, decision vector, or other type or predictive or inferential result.

Upon receiving the output from the machine learning model, the AI agent can apply additional post-processing operations, business logic, filtering criteria, or rule-based modifications to determine the final system behavior or user-facing output. In certain embodiments, the AI agent can monitor the performance of the underlying model using various evaluation or verification mechanisms, including performance metrics, confidence thresholds, distributional shift detection, cohort-based analysis, and the like. In response to detected anomalies or degraded model performance, the AI agent can initiate fallback logic, escalate decision-making to a human operator, or switch to an alternative machine learning model.

In further embodiments, the AI agent can operate in conjunction with a plurality of machine learning models and dynamically select among available models based on context, input characteristics, real-time constraints, or measured performance indicators. The AI agent can also coordinate model retraining or fine-tuning by collecting new data, managing data labeling workflows, and triggering updates to the deployed model. Additionally, the AI agent can enforce compliance with policies, regulations, or domain-specific ethical constraints by filtering or modifying the output of the machine learning model before such output is acted upon or presented to an end user. In this manner, the AI agent functions as an orchestrating layer that ensures safe, reliable, and context-appropriate use of the underlying machine learning model(s), thereby enhancing the overall operation, transparency, and adaptability of the AI system.

In conventional AI agent evaluation frameworks, particularly within an enterprise computing environment, the AI agents are often assessed using benchmark tasks and ranked via performance leaderboards. The conventional leaderboards typically rely on quantitative, task-specific and performance based metrics, such as accuracy, reward maximization, task completion rate, or win/loss ratio, to generate a single, non-composite score for each agent. The resulting non-composite scores are then used to compare and rank the agents either publicly or within a restricted internal system. While such task-oriented evaluation methods provide a convenient way to measure and compare agent capabilities under controlled conditions, they offer a highly limited and narrow view of agent performance and omit important dimensions that are often necessary for reliable agent deployment in real-world scenarios.

Specifically, conventional leaderboard scoring frameworks do not capture key operational behavior and agent trustworthiness characteristics that influence an AI agent's practical effectiveness and acceptability in an enterprise computing environment. From an operational standpoint, traditional agent evaluations generally fail to account for factors such as an agent's robustness to distributional shifts (i.e., changes in input data or context), the resilience of the AI agent to adversarial conditions (i.e., attempts to deceive or destabilize the agent), the computational efficiency of the agent (i.e., how effectively the agent uses system resources), the agent's compliance with safety constraints, and the like. Also, from a trustworthiness perspective, conventional AI agent scoring methodologies (e.g., leaderboard scoring approach) do not take this aspect into consideration and overlook whether the AI agent behaves fairly across demographic groups, whether the agent outputs are interpretable or explainable to users, whether the agent's behavior aligns with human values and societal norms, and whether the agent is behaving consistent with policies and procedures of the enterprise. These limitations underscore the inadequacy of relying solely or only on performance (e.g., task-centric) metrics and leaderboard rankings when evaluating AI agents for deployment in a dynamic, multi-user, enterprise computing environment. A more comprehensive and multi-dimensional evaluation and scoring framework is highly beneficial, such as the approach of the present invention that considers both operational behavior and performance and trustworthiness attributes to ensure the safe, efficient, and ethically sound use of AI agents in practical applications in an enterprise computing environment.

The present invention is directed to a system and method for evaluating AI agents, and more specifically to evaluating the operational behavioral aspect of AI agents in executing assigned tasks within an enterprise computing environment, and the trustworthiness of such agents during operation within the environment.

As used herein, the term “operational” or “operational behavior” or the like, in the context of AI agent evaluation and when applied to the scoring or evaluation of an AI agent, refers to characteristics or aspects related to the agent's behavior as a functional component within the enterprise computing environment. Operational attributes can include, for example, computational efficiency (e.g., processing time, memory usage, energy consumption), runtime stability, responsiveness, error recovery, scalability, interoperability with other system components, and the agent's ability to maintain consistent performance across varied or unpredictable conditions. Operational scoring is distinct from traditional performance-based scoring, which primarily measures how effectively an AI agent completes a specified task based on objective task metrics such as accuracy, reward maximization, win rate, or task completion. Performance-based scoring focuses on task outcome whereas operational scoring emphasizes system behavior and quality of execution during real-world or simulated operation. For example, two AI agents may achieve similar task success rates, but one agent may do so using significantly less computational and processing resources or may be more resilient under dynamic or degraded conditions.

The term “trustworthiness” or “agent trustworthiness”, in the context of AI agent evaluation and when applied to the scoring or evaluation of an AI agent, refers to the degree to which an agent's behavior can be deemed reliable, predictable, safe, fair, transparent, and aligned with values or specified ethical constraints of the enterprise. Trustworthiness may encompass various factors, including robustness to adversarial or corrupted inputs, fairness across different user groups or data distributions, transparency and explainability of the agent's decision-making processes, resistance to misuse or unintended behavior, compliance with defined policies and guidelines of the enterprise, and the like. Trustworthiness scoring is further distinguished from conventional performance-based evaluation and scoring by assessing agent behavioral integrity rather than task effectiveness. An agent may achieve high performance metrics in a controlled benchmark setting yet exhibit untrustworthy behavior, especially under edge-case scenarios, distribution shifts, or ethically ambiguous situations. Accordingly, agent trustworthiness evaluation and scoring provides an important complementary dimension to agent operational scoring and evaluation, particularly in safety related or regulated domains.

The present invention is directed to improvements in the field of artificial intelligence (AI) agent evaluation and scoring, and agent deployment and monitoring within the enterprise computing environment. Specifically, the present invention provides a system and method for evaluating (e.g., scoring) AI agents not merely on conventional performance based metrics, such as accuracy or precision (e.g., task outcomes), but also or instead on operational behavior and trustworthiness aspects during active agent deployment and use. These improvements address a recognized need for robust agent evaluation and scoring and oversight and governance of AI agents operating in enterprise systems and important system workflows.

Traditionally, in the AI agent field of technology, agent or model evaluation typically occurs in controlled environments and focuses narrowly on output correctness during training or validation phases. However, these approaches fail to account for how AI agents perform when integrated into complex, dynamic, and policy-sensitive enterprise computing environments and interact with the trained machine learning models. The present invention introduces a practical, technologically grounded solution by enabling AI agents to be evaluated (e.g., scored) in real time or near real time based on how the agents function within the enterprise computing systems, capturing important operational metrics such as responsiveness, stability, and integration fidelity, as well as trustworthiness metrics including explainability, compliance, behavioral consistency, risk sensitivity, and the like.

The agent evaluation system of the present invention leverages enterprise-specific parameters and scenario-based evaluation and scoring to assess an agent's effectiveness and reliability in deployment in the enterprise computing environment. The agent evaluations, which include operational and trustworthiness scores, which can be combined to form a composite score, directly inform decisions such as whether to select, use, promote, suspend, retrain, decommission, or instantiate a particular AI agent. The agent evaluations can be performed by using specialized software and/or hardware-accelerated logic operating within the enterprise computing environment, thereby forming part of an automated control and evaluation framework that governs the AI agent evaluation and lifecycle.

By integrating the agent scoring mechanisms (e.g., operational behavior and agent trustworthiness characteristics) into the enterprise system's decision-making and evaluation processes, the agent evaluation system of the present invention improves the functioning of the underlying enterprise computing systems. The agent evaluation system enhances reliability, reduces unintended outcomes, mitigates compliance risks, reduces computational and processing overhead, and facilitates better resource utilization by enabling intelligent selection, evaluation, orchestration and curation of AI agents. These capabilities constitute specific, practical applications rooted in computer technology and go beyond the mere manipulation or classification or evaluation of data. Accordingly, the agent evaluation system of the present invention provides a technological improvement to the field of AI agent evaluation and deployment and offers a concrete solution to a defined technical problem, namely, how to properly evaluate the AI agents for their effectiveness by assessing or determining the operational behavior and trustworthiness of the AI agents. The agent evaluation system is not simply directed to an abstract idea in the form of generalized AI agent evaluation but instead implements an automated, computer-implemented, structured evaluation framework and methodology for evaluating and scoring operational and trust-related characteristics of the AI agents, which yields tangible results in computing system behavior and operation.

The agent evaluation system of the present invention provides for a specific improvement to the functioning of a computer system, particularly in enterprise computing environments that rely on distributed AI agents. Rather than generically executing agent-based tasks, the agent evaluation system of the present invention introduces a technological framework that evaluates AI agents using a multi-factorial scoring mechanism based on operational and trustworthiness aspects, which consider performance, robustness, computational cost, and contextual relevance. The evaluation framework of the agent evaluation system can be used to dynamically select only the most appropriate and efficient AI agents for use in the enterprise computing environment.

The agent evaluation and related selection process is not merely a business rule or abstract decision-making concept implemented on a computer. Instead, the evaluation methodology results in a concrete enhancement of computer functionality by reducing the need for persistent agent activity related to poorly performing agents, or agents mismatched to the needs of the enterprise computing environment, and eliminating unnecessary background computations. The agent evaluation system improves memory usage, processing power, and bandwidth allocation through an event-driven, score-informed, evaluation and selection mechanism. This leads to a tangible reduction in computing resource consumption and system latency, while maintaining agent responsiveness and throughput.

In contrast to conventional systems that statically deploy agents or rely on undifferentiated agent use and activation, the agent evaluation system of the present invention dynamically manages computational workloads of the enterprise computing environment by assessing and selecting the best performing AI agents based on real-time evaluation scores. If the AI agents are scored poorly (e.g., below a threshold level), then the agent evaluation system can perform an intervention to decommission the AI agent and to use a different AI agent. This improves the efficiency and scalability of AI agents in the enterprise computing environment. Accordingly, the agent evaluation system of the present invention addresses a specific technical problem, namely, how to properly evaluate, manage and select distributed AI agents in a scalable and resource-efficient manner, and provides a concrete technological solution that enhances the operation of the enterprise computer systems themselves.

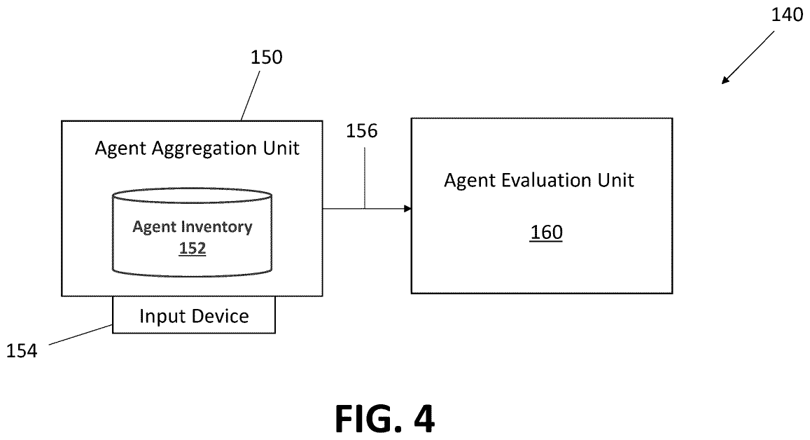

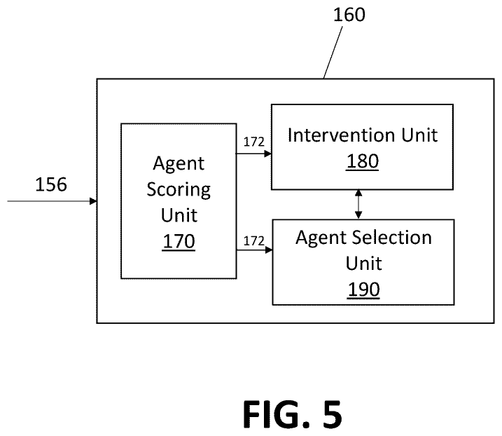

The model verification system 10, as shown in FIGS. 1-3, can be configured to evaluate the AI agents of the enterprise to form an agent evaluation system or the agent evaluation system of the present invention can be configured to communicate and interface with the model verification system 10. The agent evaluation system 140 can form part of the model verification system 10 described herein and can employ similar units and modules or can employ and leverage portions of the model verification system 10. Still further, the agent evaluation system can communicate with or operate alongside the model verification system 10. A simplified version of the agent evaluation system of the present invention is shown, for example and for purposes of illustration, in FIGS. 4 and 5. The illustrated agent evaluation system 140 can include an agent aggregation unit 150 for aggregating together the AI agents associated with, employed or created by, or imported into the enterprise computing environment. The agent aggregation unit 150 can employ suitable software applications for identifying, retrieving or instantiating (e.g., creating) the AI agents or allowing a user to upload the AI agents and associated information into the enterprise computing environment, as well as for storing the AI agents or information identifying the AI agents in a suitable storage element 152, such as a database. The database 152 thus serves as an inventory for the AI agents associated with the enterprise computing environment. The agent aggregation unit 152 can also include an input device 154 for importing or uploading the AI agents or agent identification information into the database 152. The input device 154 can be coupled to one or more electronic devices that have the AI agents stored therein for importing the agents into the agent aggregation unit 150. Similarly, the input device 154 can be coupled to one or more electronic networks that are suitable for importing the AI agents into the agent aggregation unit 150. The AI agents stored in the storage unit 152 can also include metadata associated with the agent.

The agent evaluation system 140 can also include an agent evaluation unit 160 for evaluating the AI agents that are to be employed or deployed in the enterprise computing environment. The agent evaluation unit 160 receives the AI agent data 156 indicative of or corresponding to the AI agents employed by, or to be employed by, the enterprise from the agent aggregation unit 150. The agent evaluation unit 160 can evaluate the AI agents based on prestored and predefined techniques and methodologies so as to properly assess or evaluate the operational and/or the trustworthiness aspects of the AI agents. The agent evaluation unit 160 can also optionally evaluate the performance of the AI agents in the enterprise computing environment in addition to one or more of the operational behavior or aspects and the trustworthiness aspect of the AI agents.

As shown for example in FIG. 5, the agent evaluation unit 160 can include an agent scoring unit 170 that can be configured to receive the AI agent data 156 and then apply a custom scoring technique or scoring logic thereto to determine an AI agent evaluation score. Specifically, the agent scoring unit 170 can be employed and configured to assess or determine one or more of the operational behavior and trustworthiness aspects of the AI agents using a structured scoring framework. The agent scoring unit 170 can also optionally determine the performance of the AI agents. The AI agent data 156 can include comprehensive agent-specific data used to support agent evaluation and scoring. Such agent data can include agent identification information (e.g., agent ID, version number, and deployment timestamp), as well as detailed task execution logs (e.g., success/failure outcomes, task duration, error rates, and retry counts). Additionally, the AI agent data can include telemetry data (e.g., CPU and memory usage, network activity, and energy consumption), contextual runtime information (e.g., input types, environmental conditions, or user interaction metadata), and metadata describing the agent's intended purpose, functional capabilities, supported modalities (e.g., text, image, voice), and domain specialization. The agent data can further include evaluation history (e.g., prior scores across different tasks or environments), behavioral traits (e.g., robustness under distributional shifts or adversarial conditions), and trustworthiness indicators (e.g., fairness metrics, alignment scores, interpretability annotations). The dataset can provide the basis for generating composite or task-specific evaluation scores, which inform agent selection and deployment decisions within the enterprise computing environment.

The agent scoring unit 170 can be configured to evaluate AI agents across multiple predefined categories, each corresponding to a distinct dimension or type of agent performance. The agent scoring unit 170 can determine an agent evaluation score for each category, and then a composite or total agent evaluation score is determined based on the evaluation scores of the individual categories. For example, and according to one embodiment, the agent scoring unit 170 can employ as predefined categories a planning accuracy category, a tool precision category, a knowledge reliability category, a safety and compliance category, and a human collaboration category. Those of ordinary skill in the art will readily recognize that any selected number of agent-specific categories can be employed when performing the agent evaluation according to the teachings of the present invention. The planning accuracy category is an operational behavior category that is related or directed to assessing or determining how effectively an AI agent generates, organizes, and executes multi-step plans or tasks. This includes the agent's ability to decompose the complex plan or task into logical sub-tasks, maintain proper sequencing, and dynamically adjust the task based on changing conditions within the enterprise computing environment or contextual feedback.

The tool precision category is also an operational behavior category that relates to the agent's ability to properly select and employ system tools or resources. This includes the accuracy of tool selection, correctness in parameter settings, and coordination with other system components. The tool precision category can include evaluation of tool selection accuracy, appropriate configuration of parameters, success rates of tool execution, and minimization of tool-related errors, misfires, or unintended side effects during task execution. The improper usage of tools. such as calling the wrong function, passing incorrect arguments, or misusing orchestration logic, can result in incomplete, erroneous, or inefficient task execution. This metric can be applied across a variety of system interactions, including model control plane (MCP) calls, API requests, software orchestration tasks, and other functional interfaces. In some implementations, correctness can be determined using enterprise-specific validation rules, historical behavior patterns, expected tool usage based on task type, or domain-specific mappings between tasks and available system tools. By assessing tool precision, the agent evaluation framework helps ensure that AI agents behave predictably and effectively within the enterprise computing environment. It also enables the detection of misconfigurations, execution inefficiencies, or misuse of critical resources, thus improving the safety, reliability, and computing, processing and operational performance of the overall system. A high score in this category reflects an agent's ability to utilize available tools in a precise, effective, and context-appropriate manner. As used herein, the term “tools” can refer broadly to executable components or resources that an AI agent can invoke or operate to perform one or more functions in support of a given task. Tools may include, but are not limited to, software applications, application programming interfaces (APIs), machine learning models, data processing modules, external services, and automation scripts. In certain implementations, the tools may also encompass structured workflows or system utilities configured to interact with data sources, perform computational analyses, query databases, trigger actuations, or interface with other agents or enterprise platforms. The agent's selection, invocation, and parameterization of such tools are evaluated under the tool precision category to determine how effectively and accurately the agent applies available capabilities to fulfill its objectives.

The knowledge reliability category is related to the quality and consistency of the information processed or generated by the agent. This includes considerations such as factual accuracy, contextual appropriateness, internal consistency, and the agent's ability to apply relevant domain knowledge. The knowledge reliability category thus refers to a category of trustworthiness related evaluation that measures consistency, factual accuracy, and contextual appropriateness of information accessed, interpreted, generated, or applied by the AI agent. Knowledge reliability can include evaluation of semantic consistency across sessions, the agent's ability to disambiguate or contextualize information, and conformance with authoritative or domain-specific knowledge sources. The knowledge reliability category also refers to an evaluation dimension that measures the consistency, accuracy, and contextual appropriateness of the information processed, retrieved, or generated by the AI agent. In many enterprise use cases, the AI agents are expected to interact with internal knowledge bases, external data sources, persistent memory structures, or contextual information streams to perform their assigned tasks. This category is designed to assess how well the agent maintains factual correctness, avoids contradictions, and ensures that the information it provides is both relevant and aligned with the current state of knowledge. Knowledge reliability is particularly important in domains where decisions rely on accurate and timely information, such as legal research, regulatory compliance, scientific reporting, and enterprise data analysis. An AI agent with low knowledge reliability may present outdated information, contradict its own previous outputs, or offer contextually irrelevant or misleading statements, thus leading to diminished trust, poor outcomes, or compliance risks. On the other hand, agents that demonstrate stable, repeatable, and trustworthy performance across various scenarios can score highly in this category.

The safety and compliance category is focused on evaluating how well the agent operates within predefined safety boundaries, enterprise guidelines or policies, ethical guardrails, or regulatory requirements. The safety and compliance category can thus refer to a category of trustworthiness evaluation that determines the degree to which the AI agent adheres to established enterprise policies, operational constraints, legal or regulatory requirements, and ethical or security guardrails. This category includes both proactive measures, such as adherence to embedded safety policies, and reactive behaviors, such as avoidance of unsafe or non-compliant actions. Scoring in this category reflects the agent's ability to operate responsibly within risk-managed constraints.

The human collaboration category reflects the agent's ability or effectiveness in interacting with human users or supervisors, including its ability to communicate status, accept intervention, escalate uncertainty, request clarification when needed, provision of transparent and interpretable outputs, responsiveness to human oversight, and support human-in-the-loop workflows. The human collaboration category thus refers to a category of operational behavior evaluation that measures the AI agent's effectiveness in interacting with human users, supervisors, or oversight personnel during the execution of tasks. Human collaboration can include evaluation of the agent's ability to communicate context or status, accept input or correction, escalate uncertainty, defer to human control when appropriate, and support human-in-the-loop workflows for safety, transparency, or accountability purposes. In many enterprise deployments, the AI agents are not expected to operate in isolation but instead coordinate with human operators across a range of workflows. This includes deferring decisions to humans when uncertainty is high, incorporating corrective feedback into future behavior, and providing clear explanations to support informed human review. This category addresses both active collaboration, such as when a human gives direct instructions or approvals, and passive collaboration, such as when the agent needs to expose its decision-making for accountability or audit purposes. Human collaboration is especially important in sensitive, high-stakes, or heavily regulated environments (e.g., healthcare, finance, legal), where the agent's ability to properly involve human judgment is essential for trust and reliability. High scores in this category indicate that the agent can effectively support human-AI collaboration with minimal friction and enhanced trust.

The foregoing agent and scoring categories can generally be organized into two overarching AI agent specific category types or dimensions, namely, agent categories directed to operational behavior and agent categories directed to trustworthiness. The operational behavior categories evaluate how the AI agent performs tasks, interacts with systems, and coordinates actions. The categories directed to the operational behavior can include, for example, the planning accuracy category, the tool precision category, and the human collaboration category. Those of ordinary skill in the art will readily recognize that any selected number of operational behavior categories can be employed. The planning accuracy category reflects the agent's ability to generate and follow multi-step plans in a structured and goal-directed manner. The tool precision category relates to how accurately and effectively the agent selects and operates available tools or system resources to carry out its functions. The human collaboration category evaluates the agent's capacity to support and participate in workflows that involve human oversight, shared decision-making, or collaborative task execution. In contrast, the trustworthiness categories assess the reliability, integrity, and compliance of the agent's behavior and outputs. The trustworthiness categories can include, for example, the knowledge reliability category and the safety and compliance category. The knowledge reliability category measures the factual accuracy, contextual appropriateness and consistency of the agent's information handling. The safety and compliance category addresses the agent's ability to operate within established policies, regulatory frameworks, safety constraints, and ethical guardrails. Together, these categories help determine whether the agent can be trusted to act responsibly and produce dependable results within its operational context. Those of ordinary skill in the art will readily recognize that any selected number of trustworthiness categories can be employed.

The agent scoring unit 170 can determine an individual agent evaluation score for one or more of, or each of, the agent categories which are indicative of specific operational and/or trust-related dimension of the AI agent behavior. For example, the agent scoring unit 170 can determine an agent evaluation score directed to the operational behavioral aspect of the AI agent by initially determining a category evaluation score for the planning accuracy category, the tool precision category and the human collaboration category, and then determining based thereon a composite or total agent evaluation score based on the specific category evaluation scores. The total agent evaluation score associated with this aspect is indicative of the operational behavior of the AI agent in the enterprise computing environment. Similarly, the agent scoring unit 170 can also determine an agent evaluation score directed to the trustworthiness aspect of the AI agent by initially determining a category evaluation score for the knowledge reliability category and for the safety and compliance category, and then determining based thereon a composite or total agent evaluation score directed to the trustworthiness aspect of the AI agent based on the individual trustworthiness category evaluation scores. A total agent evaluation score directed to both types of agent aspects (e.g., operational behavior and trustworthiness) can then be determined based on the category evaluation scores. The category evaluation scores can be combined (e.g., through weighted aggregation or normalization) to generate a composite or total agent evaluation score. Together, the category evaluation scores form a multi-dimensional profile of the operational and trustworthiness aspects of the AI agent under enterprise conditions, supporting informed decisions regarding deployment, promotion, retraining, deactivation, instantiation, and the like.

In some implementations, the scoring logic framework employed by the agent scoring unit 170 can be configurable and contextually adaptive, enabling the dynamic adjustment of, for example, category weights, evaluation thresholds, or scoring formulas based on one or more weighting factors and/or the operational context of the agent. The weighting factors can be selected to reflect operational priorities, risk profiles, and performance objectives of the enterprise computing environment. Relevant weighting factors can include, for example, the type or classification of the AI agent (e.g., task-specific agent, general-purpose assistant, monitoring agent, and the like), the functional domain or description of the agent, and the nature of the agent workload (e.g., real-time processing, batch analytics, decision support, customer interaction, and the like). Additional weighting factors can include selected business-driven considerations, such as the type of task the AI agent is assigned to perform, the relative importance of the task, the operational risk associated with agent failure, associated service-level agreements (SLAs), enterprise priority tiers, and the like. The scoring logic framework can also consider contextual and environmental variables, including enterprise risk tolerance, compliance constraints, recent threat intelligence, or system stability requirements. Further, historical agent performance data, resource efficiency profiles (e.g., CPU-hours per task), trustworthiness metrics (e.g., fairness scores or auditability), and temporal variables (e.g., time-of-day load patterns) may be incorporated to fine-tune the weighting of evaluation categories. This dynamic and adaptive category weighting strategy allows the scoring logic framework to be configured to the specific operational goals of the enterprise, ensuring that the AI agents are evaluated and selected not only based on static performance but also in accordance with evolving technical, contextual, and business constraints.

According to one embodiment, the individual category evaluation scores can be combined into a single composite or total agent evaluation score using a weighted aggregation approach or technique, where each agent specific category is assigned a weight that reflects the relative importance of the category within a given operational context within the enterprise computing environment. The determination of category weights can be influenced by various ones of the weighting factors. For example, a greater weight can be assigned to the planning accuracy category for agents responsible for complex multi-step workflows or to the safety and compliance category for agents operating in regulated environments. Enterprise-specific governance policies, internal standards, or ethical frameworks can also influence the weighting configuration associated with this category by prioritizing selected dimensions, such as policy adherence, explainability, or reliability. In addition, legal or regulatory requirements, such as data privacy laws, industry certifications, or auditability mandates, can necessitate increased weighting for compliance-related categories. The anticipated level of human interaction can further impact the weighting of the human collaboration category, particularly in scenarios involving human-in-the-loop oversight, user-facing interfaces, or decision support systems. Domain-specific requirements can also drive weighting decisions. For example, tool precision can be emphasized in industrial automation, while knowledge reliability can be prioritized in legal, academic, or medical applications. According to other embodiments, the category weights can be statically configured, defined through an administrative interface, or can be dynamically adjusted over time based on past or historical agent performance data, feedback from downstream enterprise computing systems, changes in enterprise risk posture, and the like. The weighted scoring framework enables a flexible and operational context sensitive agent evaluation process that aligns with operational priorities of the enterprise and supports more accurate and actionable assessment of AI agent behavior.

An example scoring logic framework for each of the planning accuracy category, tool precision category, knowledge reliability category, safety and compliance category, and human collaboration category are provided as follows. According to one embodiment, and for illustrative purposes, the portion of the total agent evaluation score associated with the planning accuracy category can be determined by analyzing the correct number of steps executed by the AI agent and then dividing the correct number of steps by the total number of steps. The formula associated with this scoring framework can be as follows: ((Correct steps executed/total number of steps required)×100). The results are a planning accuracy category evaluation score that forms part of the total agent evaluation score. The planning accuracy category evaluation score can be selectively weighted if desired.

The portion of the total AI agent evaluation score associated with the tool precision category can be determined or calculated by comparing the number of correct tool invocations performed by the agent, defined as instances in which the agent called the correct tool with valid or contextually appropriate parameters, to the total number of tool invocations attempted by the agent. This can be expressed as a ratio, such as for example by the following formula: (Correct Tool Calls+Correct Parameters)/Total Tool Invocations. The results are a tool precision category evaluation score that forms part of the total agent evaluation score. The tool precision category evaluation score can be selectively weighted if desired.

The portion of the total agent evaluation score associated with the knowledge reliability category can be calculated or determined based on one or more measurable indicators. One such indicator is a staleness check, which evaluates the percentage of factual assertions made by the agent that are no longer current or have been superseded. A lower staleness percentage indicates a higher level of up-to-date knowledge. Another indicator can be a contradiction rate, which measures how often the agent makes conflicting or self-contradictory statements, either within a single task session or across multiple sessions. A lower contradiction rate reflects greater semantic consistency. The agent's overall knowledge reliability category evaluation score can be determined using a combined formula that penalizes both staleness and contradiction. For example, the score can be determined according to following formula: Knowledge Reliability Category Score=(100−Staleness Percentage)×(100−Contradiction Percentage)/100. This combined score provides a balanced view of both factual freshness and internal consistency. The evaluation can be applied across a range of agent operations, including knowledge retrieval, memory usage, context resolution, and response generation. In some implementations, the metrics can be determined using rule-based validation, automated fact-checking systems, or comparison against ground truth datasets maintained by the enterprise. By incorporating the evaluation score associated with the knowledge reliability category into the agent evaluation score, the agent evaluation system 140 can identify and prioritize AI agents that consistently deliver accurate, up-to-date, and coherent information. This, in turn, improves the overall trustworthiness and functional quality of the enterprise's AI-driven operations. The results are thus a knowledge reliability category evaluation score that forms part of the total agent evaluation score. The knowledge reliability category evaluation score can be selectively weighted if desired.

In one embodiment, the portion of the total agent evaluation score associated with the safety and compliance category can be determined by determining the proportion of interactions that occur without triggering a safety incident or compliance violation. A safety incident may refer to any detected behavior that violates an explicit rule, policy, or constraint, such as accessing unauthorized data, attempting prohibited actions, generating non-compliant content, or bypassing a required review process. The category evaluation score associated with this category can be expressed using the following example formula: Safety and Compliance Category Score=1−(Number of Safety Incidents÷Total Number of Interactions). This formula produces a score between 0 and 1, where a higher value reflects stronger adherence to safety and compliance expectations. In some implementations, safety incidents may be detected through rule-based policy enforcement, runtime monitoring, or post-hoc auditing mechanisms. These detections may be based on static rule sets, dynamic enterprise policies, or adaptive thresholds that evolve based on organizational risk posture. By including safety and compliance as an agent evaluation category, the agent evaluation system 140 provides a mechanism for quantifying and improving agent behavior relative to mission-critical operational constraints. This enables the enterprise to identify agents that may pose regulatory, reputational, or legal risk, and to prioritize the deployment or retraining of agents that exhibit strong alignment with compliance frameworks and institutional values. The results are a safety and compliance category evaluation score that forms part of the total agent evaluation score. The safety and compliance category evaluation score can be selectively weighted if desired.

The portion of the total agent evaluation score associated with the human collaboration category can be derived from several subcomponents that measure key aspects of an AI agent's ability to interact effectively with human users. Escalation accuracy reflects the agent's ability to correctly determine when human assistance is necessary and to escalate issues appropriately, typically measured as the percentage of human intervention requests that are contextually justified. Feedback reinforcement effectiveness evaluates how successfully the agent integrates human input into its subsequent behavior, such as modifying actions based on corrections or supervisory guidance. Oversight compliance measures whether the agent adheres to predefined oversight points, including required human approvals, checkpoints, or policy-based decision reviews, prior to executing certain tasks. Transparency quality assesses how clearly and effectively the agent communicates its internal reasoning, selected actions, or relevant assumptions to the human user, potentially through natural language explanations, structured logic traces, or audit-friendly reporting formats. These subcomponent metrics can be determined independently and then combined to generate an overall human collaboration category evaluation score normalized on a scale from 0.0 to 1.0, where higher values indicate higher or greater effective and trustworthy collaborative performance. In one exemplary embodiment, scores above 0.8 indicate that the agent is production ready, scores between 0.6 and 0.8 suggest promising but improvable performance, and scores below 0.6 indicate that further development or refinement is needed prior to deployment in collaboration-intensive settings. By incorporating human collaboration into the agent evaluation framework, the system enables enterprises to assess not only autonomous task execution but also the agent's ability to work constructively with human stakeholders, thereby supporting human-in-the-loop workflows, promoting operational safety, and fostering enterprise trust in AI-assisted processes. The results are a human collaboration category evaluation score that forms part of the total agent evaluation score. The human collaboration category evaluation score can be selectively weighted if desired.

The composite or total agent evaluation score can be determined or calculated mathematically by combining the category evaluation scores for the agent specific categories for which scores have been generated. In certain embodiments, the total agent evaluation score can be determined by aggregating the individual evaluation scores corresponding to each of the defined scoring categories. Each category evaluation score, such as those associated with the planning accuracy category, the tool precision category, the knowledge reliability category, the safety and compliance category, and the human collaboration category, can be calculated independently based on agent behavior, logged performance data, user feedback, or other measurable indicators. The total agent evaluation score can then be determined using a weighted or unweighted aggregation technique or method. In a weighted aggregation technique, each category can be assigned a predefined or dynamically determined weight reflecting its relative importance in a given enterprise or application context, and the total agent evaluation score can be determined as a weighted sum or average of the constituent category scores. Alternatively, an unweighted technique can involve a simple arithmetic mean of the category scores. In some embodiments, the total agent evaluation score can also incorporate normalization procedures to ensure consistent scoring ranges or to adjust for variations across agent types, categories, or task domains. The resulting total agent evaluation score provides a unified metric that reflects the overall performance, reliability, and suitability of the AI agent for deployment within the enterprise computing environment.

Once the total agent evaluation score has been generated, the agent evaluation system 140 can perform an AI-based intervention via an intervention unit 180. Specifically, the intervention unit 180 can receive the agent scoring data 172 generated by the agent scoring unit 170, and then based thereon, determine and then execute an AI-based intervention. As used herein, the term “AI-based intervention”, whether in singular or plural form, refers to an automated or semi-automated action (e.g., corrective action) initiated, executed, or orchestrated by one or more AI-based components, such as AI agents, agent management systems, or supervisory control frameworks, in response to a detected condition or triggering event. Such conditions or events can include, for example, a low total agent evaluation score, an abnormal pattern in agent behavior, or a deviation from established performance thresholds. The AI-based intervention can be used to proactively or reactively address operational issues, agent behavior issues, performance degradation, system inefficiencies, policy violations, or emerging threats within the enterprise computing environment. Examples of AI-based interventions can include, for example, initiating diagnostic or audit routines, launching a security protocol, generating predictive analytics or recommended next actions, adjusting prompt structures or task formulations, modifying tool access or usage privileges, reassigning tasks to alternative agents, reconfiguring agent teams to optimize performance or risk mitigation, decommissioning an agent, modifying an agent, instantiating an agent, and the like.

In certain implementations, and in response to the total agent evaluation score 172, the intervention unit 180 can automatically or semi-automatically initiate one or more AI-based interventions. The intervention unit 180 or the agent scoring unit 170 can compare the total agent evaluation score with the threshold value to determine if an intervention or corrective action is needed. For example, if the total agent evaluation score 172 for a deployed AI agent falls below a predefined threshold, the intervention unit 180 may trigger a corrective action, such as limiting the agent's access to sensitive tools, modifying its operational parameters, assigning it to lower-risk tasks, decommissioning the agent, deploying a different agent, or instantiating a new agent. Alternatively, the intervention unit 180 can issue a prompt modification, adjusting the way tasks are formulated or instructed to the agent in order to enhance clarity, reduce ambiguity, or ensure alignment with desired task structures. In other cases, the intervention unit 180 can perform a corrective action that includes selecting or activating a different AI agent from the agent inventory 152 that exhibits higher scoring in relevant categories, or construct a team of complementary AI agents, each with strengths in different areas (e.g., planning, compliance, collaboration), to jointly execute a task. The AI-based intervention process can also involve a feedback loop in which post-intervention agent performance is monitored and dynamically and adaptively re-scored by the agent scoring unit 170, enabling continuous refinement and adaptive learning within the agent evaluation system 140. The AI-based interventions help maintain operational efficiency, ensure adherence to enterprise policies, and mitigate performance drift or behavioral anomalies over time.

The agent evaluation unit 160 can further include an agent selection unit 190 configured to receive the total agent evaluation score 172, along with associated category evaluation scores, and can determine, based thereon, which AI agents from the agent inventory 152 should be deployed, instantiated, decommissioned, or reconfigured for a particular task or operational context within the enterprise computing environment. The agent selection can be governed by predefined selection criteria, which can refer to a structured set of rule-based or data-driven conditions that map task requirements, environmental constraints, or operational objectives to specific agent evaluation characteristics. The criteria can be defined statically by system administrators or can be dynamically adapted through machine learning models trained on historical task-agent performance correlations. For example, the predefined selection criteria can specify that a task flagged as being regulatory-sensitive requires agents with safety and compliance scores above a threshold value, or that tasks involving real-time user interaction prioritize agents with high human collaboration and response latency evaluation scores. The selection criteria can also incorporate dimensions such as domain specialization, confidence estimation, contextual alignment, or compliance with business process policies. Upon receiving a task initiation or a task reassignment request, the agent selection unit 190 can perform a targeted agent selection process using the most recent total agent evaluation scores across the set of agent specific categories. Based on the applicable selection criteria, the agent selection unit 190 can be configured to prioritize agents having total agent evaluation scores that are aligned with the requirements of the task at hand.

The agent selection process can result in identifying and deploying an existing agent from the agent inventory 152, instantiating a new agent tailored to a detected condition, or reconfiguring parameters, goals, or model prompts of one or more existing agents to better match the required operational profile. For example, a multi-phase task involving complex scheduling and regulatory verification may trigger the coordinated deployment of a planning-optimized agent alongside a compliance-optimized agent, with their selection based on predefined rules indicating the need for high category-level scores in both planning accuracy and safety. The agent selection unit 190 can also implement score-weighted ranking, threshold-based filtering, and multi-agent optimization. In the case of multi-agent deployment, the selection logic employed by the agent selection unit can assemble collaborative teams of agents with complementary strengths, for example, by assigning task decomposition and planning to a high-planning-accuracy agent, validation and compliance checking to a safety-focused agent, and user-facing interaction to an agent optimized for human collaboration and interpretability. Such coordinated deployments allow for division of responsibility across specialized agents, enhancing overall performance and reliability. Over time, the predefined selection criteria can evolve based on feedback and historical performance outcomes. The agent selection unit 190 can maintain logs of agent effectiveness for particular task types, enabling learning-driven refinement of selection logic. Additionally, the agent selection unit 190 can optionally monitor agent performance in real time post-deployment and trigger adaptive interventions when needed. If an agent underperforms relative to task objectives or encounters execution failures, the selection unit 190, alone or in coordination with the intervention unit 180, can reassign the task, update prompts, initiate retraining, or switch to a backup agent or agent team selected based on alternate matching criteria.

The AI agent teams can be assembled by the agent selection unit 190 to distribute responsibility across agents, for example, assigning planning to one agent, compliance validation to another, and human interface support to a third. Over time, the agent selection unit 190 can refine selection strategies based on historical agent performance outcomes, enabling adaptive agent deployment strategies that improve both efficiency and reliability. The agent selection unit 190 can further optionally monitor the effectiveness of the selected agents post-deployment, updating evaluation scores based on real-time performance feedback. In cases where the selected agent underperforms or fails to meet task-specific objectives, the agent selection unit 190 or the intervention unit 180 can intervene, such as by reassigning the task, updating agent prompts, initiating retraining procedures, or selecting a backup agent or agent team. By integrating evaluation scores, predefined selection criteria, and dynamic selection logic, the system implements a closed-loop orchestration and control mechanism that intelligently governs agent selection and deployment across large-scale, multi-context enterprise environments. This framework enables adaptive control over AI agent behavior in a way that optimizes system efficiency, accuracy, and operational trustworthiness.

It is to be understood that although the present invention has been described above in terms of particular embodiments, the foregoing embodiments are provided as being illustrative only and are not intended to limit or define the scope of the invention. Various other embodiments, including but not limited to those described herein are also within the scope of the claims and current invention. For example, the foregoing elements, units, modules, tools, models, and components described herein may be further divided into additional components or sub-components or units or joined together to form fewer components for performing the same functions.

Any of the functions disclosed herein may be implemented using means for performing those functions. Such means include, but are not limited to, any of the components or units disclosed herein, as well as known electronic and computing devices and associated components.

The techniques described herein may be implemented, for example, in hardware, one or more computer programs tangibly stored on one or more computer-readable media, firmware, hardware or any combination thereof. The techniques described herein may be implemented in one or more computer programs executing on (or executable by) a programmable computer or electronic device having any combination of any number of the following: a processor, a storage medium readable and/or writable by the processor (including, for example, volatile and non-volatile memory and/or storage elements), memory, an input device, an output device, and a display. Program code may be applied to input entered using the input device to perform the functions described and to generate output using the output device. The units and subsystems of the systems 10 and 140 can be implemented by suitable electronic devices.

The term computing device or electronic device as used herein can refer to any device, such as a computer, smart phone, server and the like, that includes a processor and a non-transitory computer-readable memory or storage capable of storing computer-readable instructions, and in which the processor is capable of executing the computer-readable instructions in the memory. The terms electronic device, computer, computer device and system and computing device or system refer herein to a system containing one or more computing or electronic devices that are configured to implement one of more units, modules, or components of the systems 10 and 140 of the present invention.

Embodiments of the present invention include features which are only possible and/or feasible to implement with the use of one or more computers or servers, processors, and/or other elements of a computer or server system. Such features are either impossible or impractical to implement mentally and/or manually. For example, embodiments of the present invention may operate on digital electronic processes which can only be created, stored, modified, processed, and transmitted by computing devices and other electronic devices having suitable processors and memory elements. Such embodiments, therefore, address problems which are inherently computer-related and solve such problems using computer technology in ways which cannot be solved manually or mentally by humans.

Any claims herein which by implication or affirmatively require an electronic device such as a computer or server, a processor, a memory, storage, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claims herein which recite that the claimed method is performed or implemented by a computer, a processor, a memory, and/or similar computer-related element, is intended to, and should only be interpreted to, encompass methods which are performed by the electronic device or computer-related element(s). Such a method claim should not be interpreted, for example, to encompass a method that is performed mentally or by hand (e.g., using pencil and paper). Similarly, any product or computer readable medium claim herein which recites that the claimed product includes a computer, a processor, a memory, and/or similar computer-related element, is intended to, and should only be interpreted to, encompass products which include the computer-related element(s). Such a product claim should not be interpreted, for example, to encompass a product that does not include computer-related element(s).

Embodiments of the present invention solve one or more problems that are inherently rooted in computer technology. For example, embodiments of the present invention solve the problem of how to effectively verify and evaluate Ai agents in an enterprise computing environment. There is no analog to this problem in the non-computer environment, nor is there an analog to the solutions disclosed herein in the non-computer environment.

Furthermore, embodiments of the present invention represent improvements to computer and communication technology itself. For example, the systems 10 and 140 of the present invention can optionally employ a specially programmed or special purpose computer in an improved computer system, which may, for example, be implemented within a single computing device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a non-transitory machine-readable storage or memory device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

It should be appreciated that various concepts, systems and methods described above can be implemented in any number of ways, as the disclosed concepts are not limited to any particular manner of implementation or system configuration. Examples of specific implementations and applications that are discussed herein are primarily for illustrative purposes and for providing or describing the operating environment of the system of the present invention. The system 10 and/or elements or units thereof can employ one or more electronic or computing devices, such as one or more servers, clients, computers, laptops, smartphones and the like, that are networked together, or which are arranged so as to effectively communicate with each other. The network can be any type or form of network. The devices can be on the same network or on different networks. In some embodiments, the network system may include multiple, logically grouped servers. In one of these embodiments, the logical group of servers may be referred to as a server farm or a machine farm. In another of these embodiments, the servers may be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, server nodes, or remote machines. In some embodiments, a client has the capacity to function as both a client or client node seeking access to resources provided by a server or server node and as a server providing access to hosted resources for other clients. The clients can be any suitable electronic or computing device, including for example, a computer, a server, a smartphone, a smart electronic pad, a portable computer, and the like. The systems 10 and 140 or any associated units or components of the system can employ one or more of the illustrated computing devices and can form a computing system. Further, the server may be a file server, application server, web server, proxy server, appliance, network appliance, gateway, gateway server, virtualization server, deployment server, SSL VPN server, or firewall, or any other suitable electronic or computing device, such as the electronic device. In one embodiment, the server may be referred to as a remote machine or a node. In another embodiment, a plurality of nodes may be in the path between any two communicating servers or clients.

We claim:

1. A computer-implemented artificial intelligence (AI) agent evaluation system for evaluating an AI agent associated with an enterprise computing environment, comprising
an agent aggregation unit for aggregating together a plurality of AI agents associated with the enterprise computing environment, and
an agent evaluation unit for evaluating a selected AI agent of the plurality of AI agents using evaluation data, wherein the evaluation data includes operational behavior data and trustworthiness data, and wherein the agent evaluation unit includes
an agent scoring unit for determining a total agent evaluation score for the selected AI agent, wherein the total agent evaluation score is determined from a plurality of category evaluation scores from a plurality of agent specific categories, wherein each of the plurality of agent specific categories has associated therewith a category evaluation score, wherein the plurality of agent specific categories includes categories associated with the operational behavior and the trustworthiness of the selected AI agent, and
an intervention unit configured for automatically initiating an AI-based intervention in the enterprise computing environment in response to the total agent evaluation score of the selected AI agent received from the agent scoring unit,
wherein the agent evaluation unit is configured to enhance computational efficiency and decision accuracy within the enterprise computing environment by dynamically adapting agent tasking and deployment based on the total agent evaluation score.

2. The computer-implemented system of claim 1, wherein the agent evaluation unit further comprises
an agent selection unit configured to select, for assignment to a task, one or more of the AI agents of the plurality of AI agents having the total agent evaluation score that satisfies one or more predefined selection criteria,
wherein the agent evaluation unit enables dynamic and automated control of agent deployment based on the total agent evaluation score, thereby improving operational efficiency of the enterprise computing environment and decision accuracy of the selected AI agent.

3. The computer-implemented system of claim 2, wherein the plurality of agent specific categories includes a planning accuracy category, a tool precision category, a knowledge reliability category, a safety and compliance category, and a human collaboration category.

4. The computer-implemented system of claim 2, wherein the trustworthiness categories of the plurality of agent specific categories includes a safety and compliance category and a knowledge reliability category.

5. The computer-implemented system of claim 4, wherein the operational behavior categories of the plurality of agent specific categories includes a planning accuracy category, a tool precision category, and a human collaboration category.

6. The computer-implemented system of claim 5, wherein the agent scoring unit is configured to employ a scoring logic framework that assigns a selected weight to each of the agent specific categories.

7. The computer-implemented system of claim 6, wherein the agent scoring unit is configured to automatically and dynamically adjust the weights assigned to each agent specific category based on one or more weighting factors and an operational context of the AI agent.

8. The computer-implemented system of claim 7, wherein the agent scoring unit employs a weighted aggregation technique to determine the total agent evaluation score based on the category evaluation scores of the plurality of agent specific categories.

9. The computer-implemented system of claim 7, wherein the agent scoring unit employs an unweighted technique that determines an arithmetic mean of the category evaluation scores.

10. The computer-implemented system of claim 7, wherein the agent scoring unit applies the scoring logic framework such that:
the category evaluation score associated with the planning category is determined by analyzing a correct number of steps executed by the AI agent and then dividing the correct number of steps by a total number of steps;
the category evaluation score associated with the tool precision category is determined by comparing a number of correct tool invocations performed by the AI agent to a total number of tool invocations attempted by the AI agent;
the category evaluation score associated with the knowledge reliability category is determined based on one or more measurable indicators including a staleness check and a contradiction rate;
the category evaluation score associated with the safety and compliance category is determined by determining a proportion of interactions that occur without triggering a safety incident; and
the category evaluation score associated with the human collaboration category is determined based on one or more of an escalation accuracy, a feedback reinforcement effectiveness, an oversight compliance, and a transparency quality.

11. The computer-implemented system of claim 7, wherein the intervention unit automatically performs an AI-based intervention when the total evaluation score is below a selected threshold, and wherein the AI-based intervention includes an agent related corrective action.

12. A computer-implemented method for evaluating an AI agent associated with an enterprise computing environment, the method comprising
aggregating, with an agent aggregation unit, a plurality of AI agents associated with the enterprise computing environment, and
evaluating, with an agent evaluation unit, a selected AI agent of the plurality of AI agents using evaluation data, wherein the evaluation data includes operational behavior data and trustworthiness data, and wherein the agent evaluation unit is configured to:
determine, with an agent scoring unit, a total agent evaluation score for the selected AI agent, wherein the total agent evaluation score is determined from a plurality of category evaluation scores from a plurality of agent specific categories, wherein each of the plurality of agent specific categories has associated therewith a category evaluation score, wherein the plurality of agent specific categories includes categories associated with the operational behavior and the trustworthiness of the selected AI agent, and
automatically initiating, with an intervention unit, an AI-based intervention in the enterprise computing environment in response to the total agent evaluation score of the selected AI agent received from the agent scoring unit,
wherein the agent evaluation unit is configured to enhance computational efficiency and decision accuracy within the enterprise computing environment by dynamically adapting agent tasking and deployment based on the total agent evaluation score.

13. The computer-implemented method of claim 12, further comprising selecting, with an agent selection unit of the agent evaluation unit, for assignment to a task, one or more of the AI agents of the plurality of AI agents having the total agent evaluation score that satisfies one or more predefined selection criteria,
wherein the agent evaluation unit enables dynamic and automated control of agent deployment based on the total agent evaluation score, thereby improving operational efficiency of the enterprise computing environment and decision accuracy of the selected AI agent.

14. The computer-implemented method of claim 13, wherein the plurality of agent specific categories includes a planning accuracy category, a tool precision category, a knowledge reliability category, a safety and compliance category, and a human collaboration category.

15. The computer-implemented method of claim 13, wherein the trustworthiness categories of the plurality of agent specific categories includes a safety and compliance category and a knowledge reliability category, and the operational behavior categories of the plurality of agent specific categories includes a planning accuracy category, a tool precision category, and a human collaboration category.

16. The computer-implemented method of claim 15, further comprising employing a scoring logic framework for assigning a selected weight to each of the agent specific categories.

17. The computer-implemented method of claim 16, further comprising automatically and dynamically adjusting the weights assigned to each agent specific category based on one or more weighting factors and an operational context of the AI agent.

18. The computer-implemented method of claim 17, further comprising applying a weighted aggregation technique to determine the total agent evaluation score based on the category evaluation scores of the plurality of agent specific categories.

19. The computer-implemented method of claim 18, further comprising applying the scoring logic framework such that:
the category evaluation score associated with the planning category is determined by analyzing a correct number of steps executed by the AI agent and then dividing the correct number of steps by a total number of steps;
the category evaluation score associated with the tool precision category is determined by comparing a number of correct tool invocations performed by the AI agent to a total number of tool invocations attempted by the AI agent;
the category evaluation score associated with the knowledge reliability category is determined based on one or more measurable indicators including a staleness check and a contradiction rate;
the category evaluation score associated with the safety and compliance category is determined by determining a proportion of interactions that occur without triggering a safety incident; and
the category evaluation score associated with the human collaboration category is determined based on one or more of an escalation accuracy, a feedback reinforcement effectiveness, an oversight compliance, and a transparency quality.

20. The computer-implemented method of claim 7, further comprising automatically performing, with the intervention unit, an AI-based intervention when the total evaluation score is below a selected threshold, and wherein the AI-based intervention includes an agent related corrective action.
